(19) United States
(12) Patent Application Publication
(10) Pub. No.: US 2024/0393131 A1
(43) Pub. Date: Nov. 28, 2024

(54) INFORMATION PROCESSING APPARATUS, SYSTEM, AND STORAGE MEDIUM

(71) Applicant: KABUSHIKI KAISHA TOSHIBA, Tokyo (JP)

(72) Inventors: Daisuke UCHIDA, Kawasaki Kanagawa (JP); Tatsuma HIRANO, Kawasaki Kanagawa (JP); Satoshi TAKAYA, Kawasaki Kanagawa (JP); Tomoya TANDAI, Ota Tokyo (JP)

(73) Assignee: KABUSHIKI KAISHA TOSHIBA, Tokyo (JP)

(21) Appl. No.: 18/582,686

(22) Filed: Feb. 21, 2024

(30) Foreign Application Priority Data
May 25, 2023 (JP) 2023-085891

(51) Int. Cl. G01C 21/00; G01C 21/34; H04B 17/318

(52) U.S. Cl. CPC G01C 21/3807; H04B 17/318; G01C 21/3461

(57) ABSTRACT

According to one embodiment, an information processing apparatus includes a processor. The processor is configured to acquire first received power measured by a moving vehicle at a first position of the moving vehicle which receives a first signal which is a radio wave, and acquire a coefficient which associates the acquired first received power with a radio wave shielding state in an environment including a second position different from the first position.

### CROSS-REFERENCE TO RELATED APPLICATIONS

This application is based upon and claims the benefit of priority from Japanese Patent Application No. 2023-085891, filed May 25, 2023, the entire contents of which are incorporated herein by reference.

### FIELD

Embodiments described herein relate generally to an information processing apparatus, a system, and a storage medium.

### BACKGROUND

In recent years, it has been known to control a moving vehicle (for example, a mobile robot) moving in a predetermined space by, for example, executing wireless communication. In this case, the moving vehicle is controlled to, for example, move along a route from a start point to a goal point set on a map of a space where the moving vehicle moves, based on a control signal for controlling the moving vehicle.

Incidentally, the above-described control signal is radiated from an antenna by a radio wave, and when an object that shields the radio wave (hereinafter, referred to as a radio wave shielding object) is disposed in the space where the moving vehicle moves, the state of radio wave shielding at a position facing the antenna with the radio wave shielding object interposed therebetween (that is, a space behind the radio wave shielding object when viewed from the antenna) deteriorates, and an insensitive area in which received power deteriorates occurs. In this case, a route which avoids the insensitive area can be selected to move the moving vehicle along the route.

Here, when the above-described radio wave shielding object is removed, the insensitive area becomes sensitive, so that the moving vehicle does not need to move, avoiding the zone.

However, it is hard to efficiently grasp the state of radio wave shielding (for example, sensitivity of the insensitive area) in the space where the moving vehicle moves.

### BRIEF DESCRIPTION OF THE DRAWINGS

FIG. 1 is a diagram illustrating an example of a local 5G system applied to an embodiment.

FIG. 2 is a diagram illustrating an example of a target space.

FIG. 3 is a diagram for explaining an example of an environment assumed in the present embodiment.

FIG. 4 is a diagram for explaining an obstacle disposed in the target space.

FIG. 5 is a diagram illustrating an example of a functional configuration of a moving vehicle.

FIG. 6 is a diagram illustrating an example of a functional configuration of an information processing apparatus.

FIG. 7 is a diagram illustrating an example of a system configuration of the information processing apparatus.

FIG. 8 is a diagram illustrating another example of the target space.

FIG. 9 is a diagram for explaining received power used for calculating regression coefficients.

FIG. 10 is a flowchart illustrating an example of a processing procedure of learning processing.

FIG. 11 is a diagram illustrating an example of a received power map.

FIG. 12 is a diagram for explaining reference positions for acquiring received power.

FIG. 13 is a diagram illustrating an example of regression coefficients.

FIG. 14 is a diagram for explaining cross-validation.

FIG. 15 is a flowchart illustrating an example of a processing procedure of estimation processing.

FIG. 16 is a diagram illustrating an example of estimated values.

FIG. 17 is a diagram illustrating an example of estimation results of presence or absence of a radio wave shielding object.

FIG. 18 is a diagram illustrating another example of the estimation results of the presence or absence of the radio wave shielding object.

FIG. 19 is a diagram illustrating still another example of the estimation results of the presence or absence of the radio wave shielding object.

FIG. 20 is a diagram for explaining a communication state based on a relationship between the actual presence or absence of the radio wave shielding object and the estimation results of the presence or absence of the radio wave shielding object.

FIG. 21 is a flowchart illustrating an example of a processing procedure of the information processing apparatus according to a first modified example of the present embodiment.

FIG. 22 is a flowchart illustrating an example of a processing procedure of the information processing apparatus according to a second modified example of the present embodiment.

FIG. 23 is a diagram for specifically explaining the second modified example of the present embodiment.

### DETAILED DESCRIPTION

In general, according to one embodiment, an information processing apparatus includes a processor. The processor is configured to acquire first received power measured by a moving vehicle at a first position of the moving vehicle which receives a first signal which is a radio wave, and acquire a coefficient which associates the acquired first received power with a radio wave shielding state in an environment including a second position different from the first position.

Various embodiments will be described with reference to the accompanying drawings.

An information processing apparatus according to a present embodiment is used to control a moving vehicle (mobile robot) that moves in a predetermined space (hereinafter, referred to as a target space) such as a factory or a warehouse.

A scenario in which the information processing apparatus according to the present embodiment is applied will be described first. When a moving vehicle moves on a straight line along a passage in the target space, the control of the moving vehicle may be simple, but for example, when the passage arranged in the target space is curved or an object disposed in the target space is avoided, more advanced control is required.

Incidentally, when such control of the moving vehicle is performed by wire (that is, a control signal for controlling the moving vehicle is transmitted by wire), there are problems that a range in which the moving vehicle can move is limited, the moving vehicle becomes out of control because of disconnection, and wiring work is complicated. Particularly, when a large number of moving vehicles move in the target space, these problems become remarkable.

In contrast, when the control of the moving vehicles is wirelessly performed (that is, the moving vehicles are wirelessly controlled), the above-described problems can be solved. For example, local 5G can be used for such wireless control of the moving vehicles. A local 5G network is a 5G network that can be individually used by, for example, a company, and can achieve high speed, low delay, and multiple simultaneous connections, thus being useful in an environment in which a large number of moving vehicles moving in the target space are wirelessly controlled. Note that a wireless LAN also can be used for wireless control of the moving vehicles.

Here, the above-described moving vehicles can be roughly divided into moving vehicles that operate autonomously and moving vehicles that operate based on a command (control signal) from outside. The moving vehicles that operate autonomously are useful because each of them can operate by determining the situation, whereas the cost is high and it is hard to apply them to a case in which a large number of moving vehicles are disposed in the target space. In contrast, in the case of the moving vehicles that operate based on a command from outside as described above, the total cost of a system including the moving vehicles and the information processing apparatus can be reduced by integrating the functions of controlling a large number of moving vehicles into one apparatus (for example, the information processing apparatus). In addition, since information of a large number of moving vehicles moving in the target space can be collectively managed, the management of the moving vehicles is relatively easy. The fact that information of a large number of moving vehicles can be collectively grasped is also advantageous from the viewpoint of the optimization of the movement of the moving vehicles as a whole.

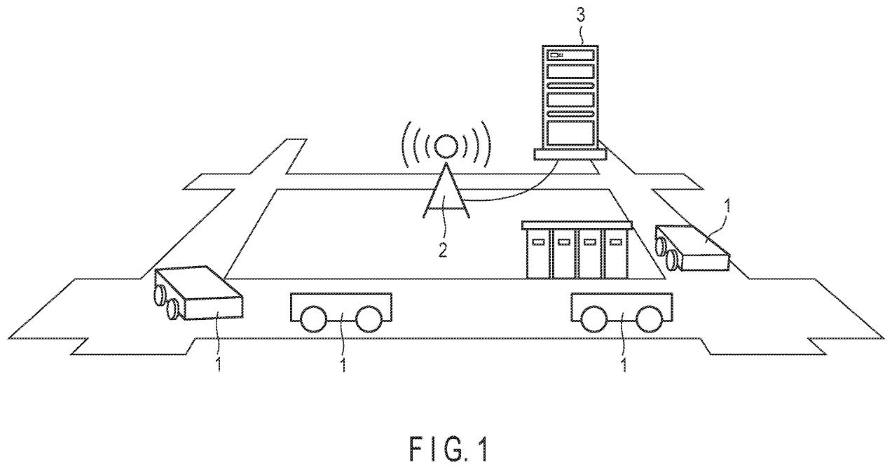

In the following description, as illustrated in FIG. 1, it is assumed that a local 5G system (cellular system) that performs terminal-side control on the base station side is applied to the present embodiment.

In the example illustrated in FIG. 1, a situation in which a plurality of moving vehicles 1 move in the target space is assumed. Each of the moving vehicles 1 has a radio device mounted thereon and is communicably connected to a base station 2. In addition, an information processing apparatus 3 is connected to the base station 2, and a control signal for controlling the moving vehicles 1 generated by the information processing apparatus 3 is transmitted from (an antenna installed in) the base station 2 to the moving vehicles 1. That is, it is possible to say that the moving vehicles 1 are communicably connected to the information processing apparatus 3 via the base station 2. The moving vehicles 1 thereby can move in the target space, based on a control signal generated by the information processing apparatus 3.

In FIG. 1, it is assumed that the moving vehicles 1 are, for example, autonomous mobile robots (AMRs), and the information processing apparatus 3 is, for example, a server apparatus referred to as a mobile edge computing (MEC) apparatus. The information processing apparatus 3 may be a server apparatus that provides a cloud computing service.

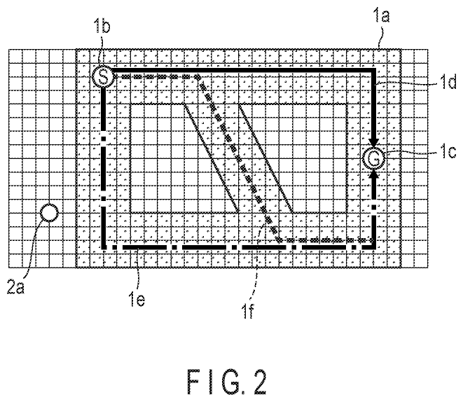

Here, it is assumed that a moving vehicle 1 is controlled to move in the target space illustrated in FIG. 2. For example, a situation in which the moving vehicle 1 moves along a passage (for example, a traveling path provided in a factory or a warehouse) la in the target space from a start point 1b to a goal point 1c in order to carry (convey) a load such as a cardboard box is assumed here.

In this case, the routes for moving from the start point 1b to the goal point 1c includes a route 1d corresponding to the shortest route, a route 1e corresponding to the longest route, and a route 1f corresponding to an intermediate route with respect to the shortest route and the longest route.

In the above-described target space illustrated in FIG. 2, the moving vehicle 1 can be controlled to efficiently move from the start point 1b to the goal point 1c by selecting the route 1d (that is, the shortest route) from the routes 1d to 1f. A control signal for controlling the moving vehicle 1 in this manner is radiated from, for example, an antenna 2a installed in the base station 2 to the moving vehicle 1. The antenna 2a is disposed, for example, in the target space. While it has been explained here that the moving vehicle 1 moves from the start point 1b to the goal point 1c in order to carry a load, a load is thus carried not only once. The moving vehicle 1 repeatedly operates to carry a load from the start point 1b to the goal point 1c, then return to the start point 1b again, and carry another load from the start point 1b to the goal point 1c. In addition, a plurality of moving vehicles 1 may carry loads from the start point 1b to the goal point 1c.

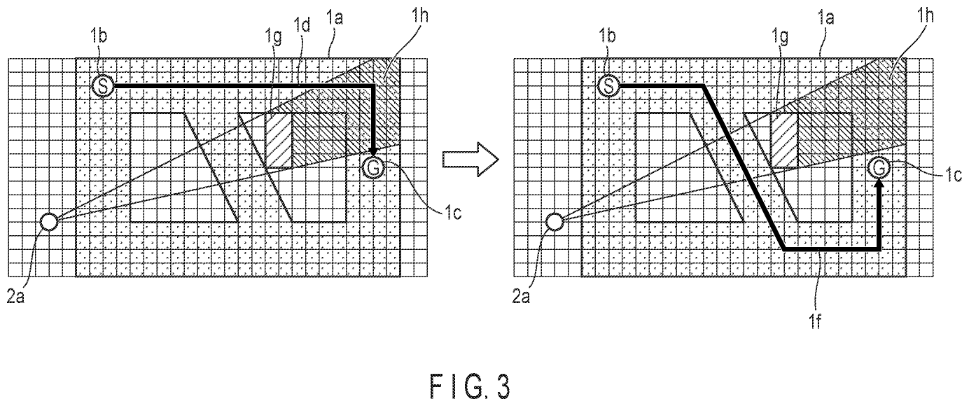

Here, when the target space in which the moving vehicle 1 moves is, for example, a factory or a warehouse, it is assumed that the arrangement of an obstacle (such as a cardboard box carried by the moving vehicle 1) in the target space changes with the lapse of time. Here, it is assumed that an obstacle 1g is disposed in the target space as illustrated on the left side of FIG. 3, for example, in a situation in which the moving vehicle 1 repeatedly carries a load from the start point 1b to the goal point 1c illustrated in FIG. 2 as described above (for example, a plurality of moving vehicles 1 sequentially move along a determined route).

In a case in which a signal (for example, a control signal) is radiated from the antenna 2a by a radio wave, when the obstacle 1g is a radio wave shielding object (for example, a cardboard box in which an object shielding a radio wave, such as metal, is packed), the radio wave radiated from the antenna 2a is shielded by the obstacle 1g, so that the state of radio wave shielding (hereinafter, referred to as a radio wave propagation environment) in a space 1h facing the antenna 2a with the obstacle 1g interposed therebetween deteriorates. An insensitive area 1h in which received power deteriorates thereby occurs.

In the example illustrated in FIG. 3, the space in which the radio wave propagation environment deteriorates (that is, the insensitive area) 1h overlaps the route 1d. Thus, when the moving vehicle 1 moves along the route 1d, there is a possibility that the moving vehicle 1 cannot normally receive a control signal in the insensitive area 1h. That is, the obstacle 1g disposed in the target space as described above becomes a factor that hinders efficient movement (control) of the moving vehicle 1.

When the insensitive area 1h occurs in this manner, the moving vehicle 1 can be controlled to avoid the insensitive area 1h by, for example, changing the route 1d to the route 1f (intermediate route) as illustrated on the right side of FIG. 3.

Incidentally, in a situation in which a plurality of moving vehicles 1 repeatedly carry loads along the route 1f changed from the route 1d (that is, the moving vehicles 1 repeatedly move between the start point 1b and the goal point 1c), when the obstacle 1g disposed in the target space is removed with the lapse of time, (the deterioration of) the radio wave propagation environment in the insensitive area 1h changes and the insensitive area 1h becomes sensitive. In this case, it is preferable that the sensitivity of the insensitive area 1h be grasped and the route along which the moving vehicles 1 move be changed again from the route 1f to the route 1d (that is, the route 1d be selected again as an appropriate route of the moving vehicles 1).

Here, a technique for grasping the sensitivity of the insensitive area 1h in a comparative example of the present embodiment will be described.

First, at an optional timing while the moving vehicle 1 is repeatedly carrying a load along the route 1f, the moving vehicle 1 is controlled to move along the route 1d, and when the moving vehicle 1 passes through the insensitive area 1h, a synchronization signal is radiated from the antenna 2a (base station 2). The moving vehicle 1 receives the synchronization signal radiated from the antenna 2a, and thereby measures the received power of the synchronization signal.

In the comparative example of the present embodiment, when the received power measured in the insensitive area 1h as described above is greater than or equal to a threshold value, it can be grasped that the insensitive area 1h become sensitive (that is, the radio wave propagation environment in the insensitive area 1h changes). In contrast, when the received power measured in the insensitive area 1h is less than the threshold value, it can be grasped that the insensitive area 1h does not become sensitive.

However, when the moving vehicle 1 is moved to the insensitive area 1h in a state in which the insensitive area 1h does not become sensitive (that is, the obstacle 1g is not removed), there is a possibility that the moving vehicle 1 cannot appropriately receive a control signal in the insensitive area 1h and does not operate normally (for example, stops operating). In this case, it takes much time until the normal operation of the moving vehicle 1 resumes, and the sensitivity of the insensitive area 1h cannot be grasped efficiently. Moreover, moving in the insensitive area 1h can cause an accident or the like due to the inability to appropriately receive a control signal (that is, an instruction to change the moving speed and the moving direction or the like).

In addition, it is conceivable that the presence or absence of the obstacle 1g is directly detected without moving the moving vehicle 1 to the above-described insensitive area 1h by, for example, using reflection of a laser radiated from the moving vehicle 1.

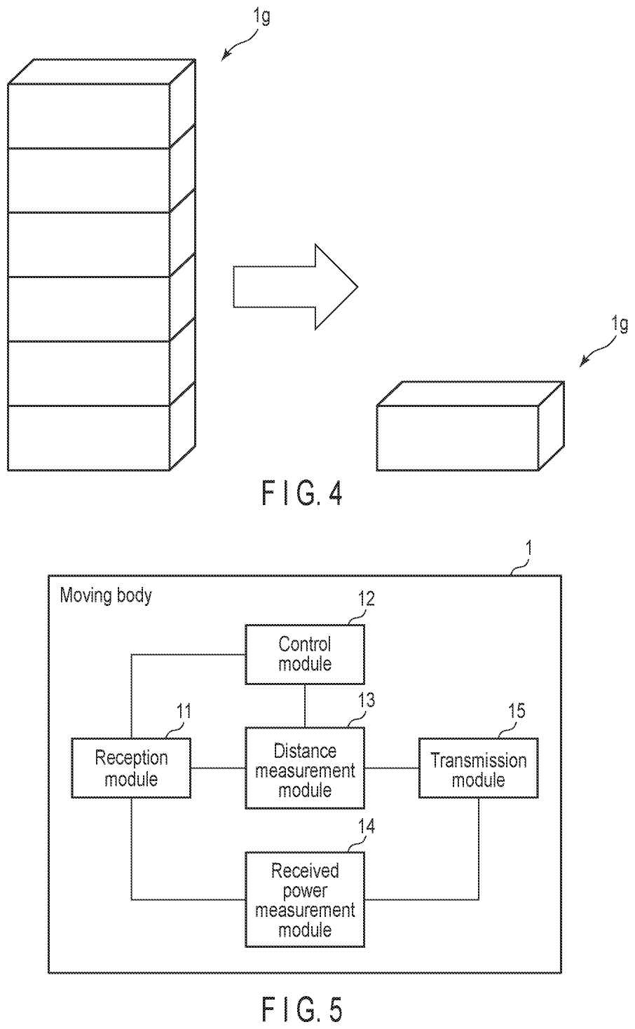

Here, in a situation in which the moving vehicle 1 moves in the target space, such as a factory or a warehouse, as described above, there is a case in which the obstacle 1g, for example, a plurality of cardboard boxes in which radio wave shielding objects are packed and which are stacked (that is, loaded) in the height direction, is disposed. In this case, the height of the obstacle 1g changes when a cardboard box is removed or further stacked. The radio wave propagation environment in a space facing the antenna 2a with the obstacle 1g interposed therebetween is considered to be dependent on the height of the obstacle 1g. Specifically, for example, in the case of the obstacle 1g having a large number of cardboard boxes stacked in the height direction as illustrated on the left side of FIG. 4, the insensitive area 1h occurs because of the obstacle 1g, whereas when the number of cardboard boxes of the obstacle 1g is reduced as illustrated on the right side of FIG. 4, the influence of the obstacle 1g becomes smaller and the insensitive area 1h may become sensitive.

However, because of the straightness of a laser radiated from the moving vehicle 1 as described above, it is hard to grasp the height direction of the obstacle 1g, and the sensitivity of the insensitive area 1h cannot be grasped in consideration of the height direction of the obstacle 1g. Applying a mechanism that can grasp the height direction to the moving vehicle 1 is also conceivable, but when a plurality of moving vehicles 1 are controlled, the cost of building a system becomes high.

Moreover, when the obstacle 1g, which is a radio wave shielding object, is replaced by an obstacle that is not a radio wave shielding object, the insensitive area 1h may become sensitivity even with the obstacle disposed.

That is, even when the presence or absence of an obstacle is detected by using reflection of a laser radiated from the moving vehicle 1, there is a case in which the sensitivity of the insensitive area 1h cannot be appropriately grasped, based on the detection result.

Thus, in the present embodiment, a moving vehicle control system which can estimate the radio wave propagation environment in a target zone (position) such as an insensitive area while avoiding a situation in which the moving vehicle 1 moves in the insensitive area and thereby cannot operate normally will be described. The moving vehicle control system according to the present embodiment includes the moving vehicle 1 (for example, an AMR) and the information processing apparatus 3 (for example, a MEC apparatus) communicably connected to the moving vehicle 1 via the base station 2 as illustrated in FIG. 1 described above.

First, an example of a functional configuration of the moving vehicle 1 will be described with reference to FIG. 5. As illustrated in FIG. 5, the moving vehicle 1 includes a reception module 11, a control module 12, a distance measurement module 13, a received power measurement module 14, and a transmission module 15.

The reception module 11 receives a control signal for controlling the moving vehicle 1. The control signal received by the reception module 11 is output to the control module 12. In addition, the reception module 11 receives a synchronization signal for measuring received power, which will be described later. The synchronization signal received by the reception module 11 is output to the received power measurement module 14. The control signal and the synchronization signal are radiated to the moving vehicle 1 from the antenna 2a installed in the base station 2.

The control module 12 controls the moving vehicle 1, based on the control signal output from the reception module 11. The moving vehicle 1 includes a wheel or the like for moving the moving vehicle 1, and the control module 12 controls the rotational speed and direction of the wheel (that is, the moving speed and direction of the moving vehicle 1) in accordance with the control signal, thereby causing the moving vehicle 1 to move. The moving speed and direction of the moving vehicle 1 controlled by the control module 12 are output to the distance measurement module 13.

The distance measurement module 13 is implemented by, for example, an optical distance sensor (laser range finder (LRF)), and measures the distance from the moving vehicle 1 to a wall or an obstacle existing around the moving vehicle 1, based on the time (time of flight (TOF)) taken for a laser (light) radiated from the LRF to be reflected. Then, (LRF scan data indicating) the distance thus measured by the distance measurement module 13 and (data indicating) the moving speed and direction of the moving vehicle 1 output from the control module 12 are output to the transmission module 15 as data for generating map data (hereinafter, referred to as data for map generation), which will be described later.

The received power measurement module 14 measures the received power (radio wave intensity) of the synchronization signal, based on the synchronization signal output from the reception module 11. Received power data indicating the received power measured by the received power measurement module 14 is transmitted to the transmission module 15.

The transmission module 15 transmits the data for map generation output from the distance measurement module 13 to the information processing apparatus 3. In addition, the transmission module 15 transmits the received power data output from the received power measurement module 14 to the information processing apparatus 3.

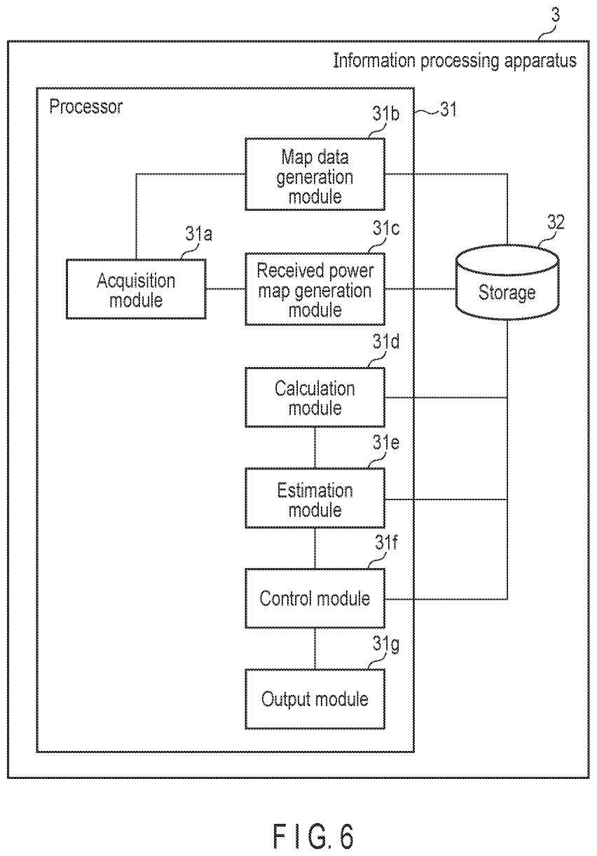

An example of a functional configuration of the information processing apparatus 3 will be described next with reference to FIG. 6. The information processing apparatus 3 according to the present embodiment is configured to acquire data from the moving vehicle 1 side via the above-described base station 2, and to instruct the moving vehicle 1 on the route (traveling route) along which the moving vehicle 1 moves.

In the present embodiment, it is assumed that the information processing apparatus 3 is a MEC apparatus. However, the information processing apparatus 3 may be implemented as a server apparatus or the like disposed far from the base station 2 via a network, or may be implemented as a local controller or the like directly connected to the base station 2.

As illustrated in FIG. 6, the information processing apparatus 3 includes a processor 31 and a storage 32. In addition, the processor 31 includes an acquisition module 31a, a map data generation module 31b, a received power map generation module 31c, a calculation module 31d, an estimation module 31e, a control module 31f, and an output module 31g.

The above-described data for map generation and received power data transmitted by the transmission module 15 included in the moving vehicle 1 are received by (the antenna 2a installed in) the base station 2. The acquisition module 31a acquires the data for map generation and the received power data received by the base station 2 from the base station 2. The data for map generation acquired by the acquisition module 31a is output to the map data generation module 31b and the received power map generation module 31c. The received power data acquired by the acquisition module 31a is output to the received power map generation module 31c.

The map data generation module 31b generates map data indicating a map of the target space, based on the data for map generation output from the acquisition module 31a. The map data generated by the map data generation module 31b is stored in the storage 32.

The received power map generation module 31c generates a received power map of the target space, based on the data for map generation and the received power data output from the acquisition module 31a. The received power map generated by the received power map generation module 31c is stored in the storage 32. The received power map is data in the form of a heat map in which received power measured at each position where which the moving vehicle 1 has moved is allocated to the positions (that is, the positions and the received power are associated with each other).

The calculation module 31d acquires received power measured at a predetermined position (hereinafter, referred to as a first position) from the received power map stored in the storage 32, and calculates a coefficient which associates the acquired received power with a radio wave propagation environment of a position (hereinafter, referred to as a second position) different from the first position, at which the received power has been measured, thereby acquiring the coefficient.

The estimation module 31e acquires received power measured at a predetermined position (hereinafter, referred to as a third position) from the received power map stored in the storage 32. The coefficient calculated by the calculation module 31d is held in the processor 31 (estimation module 31e), and the estimation module 31e uses the coefficient and the received power acquired from the received power map to estimate a radio wave propagation environment of a position different from the third position, at which the received power has been measured (that is, a radio wave shielding state in an environment including the above-described second position).

Here, in the present embodiment, the timing at which the received power used to calculate the coefficient is measured and the timing at which the received power used to estimate the radio wave propagation environment is measured are different. In other words, in the present embodiment, the information processing apparatus 3 (calculation module 31d and estimation module 31e) operates, for example, to calculate the coefficient based on the received power (first received power) measured at the first position in advance, and to estimate the radio wave propagation environment of the second position, using the coefficient and the received power (second received power) newly measured at the third position.

When the above-described first to third positions are explained with reference to, for example, the example illustrated in FIG. 3, the first and third positions correspond to positions on the route 1f, and the second position corresponds to a position encompassed in the insensitive area 1h. That is, in the present embodiment, the first and third positions are positions within the line of sight from the antenna 2a in a state in which the obstacle 1g (radio wave shielding object) is disposed, and at the first and third positions, a radio wave transmitted by the antenna 2a can be received without being shielded by the obstacle 1g. The second position is a position that is excluded from the line of sight from the antenna 2a by the obstacle 1g in a state in which the obstacle 1g is disposed, and at the second position, a radio wave transmitted by the antenna 2a is shielded by the obstacle 1g and communication is unstable (that is, the received power of the radio wave deteriorates). In the following description, for convenience, the first and third positions at which the moving vehicle 1 measures received power are referred to as received power measurement positions and the second position whose radio wave propagation environment is estimated is referred to as an estimation target position.

The control module 31f generates a control signal for controlling the moving vehicle 1, based on the map data and the received power map stored in the storage 32 and the estimation result of the estimation module 31e. The control signal generated by the control module 31f is output to the output module 31g.

The output module 31g outputs the control signal output from the control module 31f to the base station 2. The control signal thus output from the output module 31g is radiated from the antenna 2a installed in the base station 2 to the moving vehicle 1.

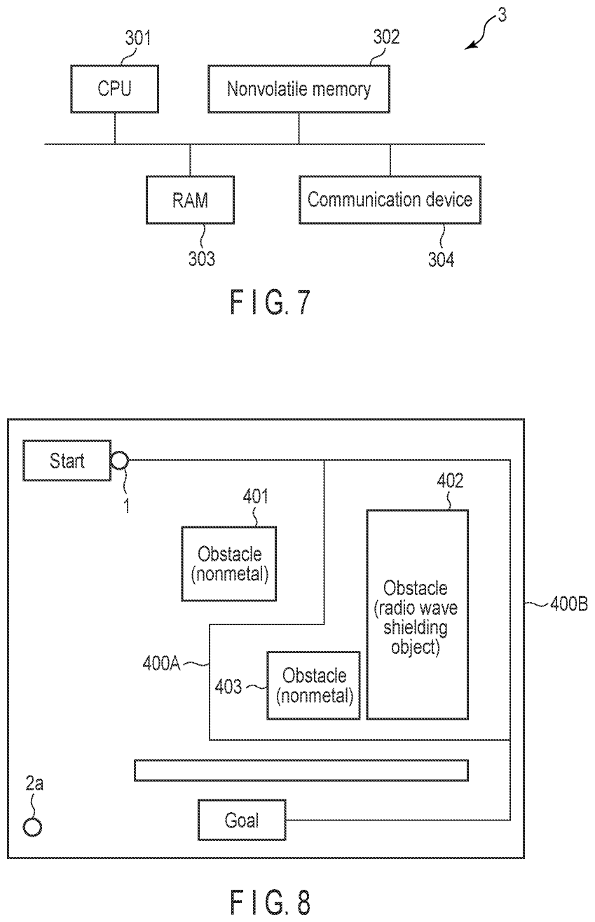

FIG. 7 illustrates an example of a system configuration of the information processing apparatus 3 illustrated in FIG. 6. The information processing apparatus 3 includes a CPU 301, a nonvolatile memory 302, a RAM 303, a communication device 304, and the like.

The CPU 301 is a processor for controlling the operation of various components in the information processing apparatus 3. The CPU 301 may be a single processor or may be composed of a plurality of processors. The CPU 301 executes various programs loaded from the nonvolatile memory 302 into the RAM 303. These programs include an operating system (OS) and various application programs.

The nonvolatile memory 302 is a storage medium used as an auxiliary storage device. The RAM 303 is a storage medium used as a main storage device. FIG. 7 illustrates only the nonvolatile memory 302 and the RAM 303, but the information processing apparatus 3 may include other storage devices, for example, a hard disk drive (HDD) and a solid-state drive (SSD).

The communication device 304 is a device configured to perform wired communication or wireless communication. The information processing apparatus 3 according to the present embodiment is assumed to be connected to the above-described base station 2 by wire (cable), but may be connected to the base station 2 via a network to perform wireless communication.

In the present embodiment, the processor 31 illustrated in FIG. 6 is implemented by at least one processor. The processor includes, for example, a control device and an arithmetic device, and is implemented by an analog or digital circuit or the like. The processor may be the above-described CPU 301, or may be a general-purpose processor, a microprocessor, a digital signal processor (DSP), an ASIC, an FPGA, or a combination thereof.

In addition, part or all of the processor 31 can be implemented by causing the CPU 301 (that is, a computer of the information processing apparatus 3) to execute a predetermined program, that is, by software. The program may be stored in a computer-readable storage medium and distributed, or may be downloaded to the information processing apparatus 3 via a network. Note that part or all of the processor 31 may be implemented by dedicated hardware or the like, or may be implemented by a combination of software and hardware.

In addition, in the present embodiment, the storage 32 illustrated in FIG. 6 is implemented by, for example, the nonvolatile memory 302 or another storage device.

Note that part or all of each of the above-described modules 11 to 15 included in the moving vehicle 1 illustrated in FIG. 5 may be implemented by causing a processor such as a CPU of the moving vehicle 1 to execute a predetermined program (that is, by software), or may be implemented by hardware, or may be implemented by a combination of software and hardware, the detailed description of which has been omitted.

In the present embodiment, the radio wave propagation environment of the estimation target position where received power has not been measured is estimated. A method (principle) for achieving such estimation will be described here.

In the following description, for convenience, it is assumed that the moving vehicle 1 moves in the target space illustrated in FIG. 8. Specifically, the moving vehicle 1 (AMR) moves, for example, in the target space where obstacles 401 to 403 are disposed as illustrated in FIG. 8. The obstacles 401 and 403 are obstacles composed of a nonmetal that does not shields a radio wave (that is, does not influence the radio wave propagation environment). In contrast, the obstacle 402 is an obstacle composed of a radio wave shielding object such as a metal that shields a radio wave (that is, influences the radio wave propagation environment).

Routes 400A and 400B are assumed as the routes along which the moving vehicle 1 moves from a start point to a goal point in the target space illustrated in FIG. 8. In this case, the route 400A is selected as the route along which the moving vehicle 1 moves, because the route 400B is a route along which the moving vehicle 1 moves through a position at which a radio wave is shielded by the obstacle 402 (that is, an insensitive area). On the other hand, since the distance of the route 400B is shorter than that of the route 400A, the route 400B should be selected when the obstacle 402 is removed.

In the scenario like this, it is assumed that the moving vehicle 1 moves along the route 400A illustrated in FIG. 8 repeatedly (that is, more than once). While the obstacle 402 (radio wave shielding object) is disposed in FIG. 8, it is assumed that the presence or absence of the obstacle 402 changes while the moving vehicle 1 is moving along the route 400A repeatedly as described above.

Here, assuming that the moving vehicle 1 is moving along the route 400A for the Xth time, received power Pᵢ of an ith position on the route 400A is modeled as Equation (1).

$${p}_{i} = {\sum }_{j = 1}^{k} {p}_{ij} {c}_{j} \qquad Equation 1$$

In Equation (1), i is an index indicating a position on the route and j is an index indicating a dominant wave. In this case, for example, j=1 can be defined as a direct wave, j=2 can be defined as a relatively strong reflected wave, j=3 can be defined as a ground-reflected wave, and j=4 can be defined as another multiple wave or the like. Note that the relatively strong reflected wave of j=2 is assumed to be, for example, a reflected wave from the above-described radio wave shielding object.

In addition, Pᵢⱼ in Equation (1) denotes the power of the dominant wave j at the position i. Cⱼ denotes whether the dominant wave j (that is, a jth wave) is present. For example, when the dominant wave j is present, Cⱼ=1. In contrast, when the dominant wave j is not present, Cⱼ=0.

Next, to explain the model of Equation (1), the propagation channels between transmission and reception are first assumed to be two waves of a direct wave and a reflected wave. In this case, as given by Equation (2) below, the total reception electric field intensity E_{T} on the reception side is expressed by the sum of the reception electric field intensity E₁ of the direct wave and the reception electric field intensity E₂ of the reflected wave.

$${E}_{T} = {E}_{1} + {E}_{2} \qquad Equation 2$$

In addition, the total received power P_{T} on the reception side is expressed as Equation (3) below, using the total reception electric field intensity E_{T} of Equation (2) described above.

$${P}_{T} = \vert {E}_{T} {\vert}^{2} = \vert {E}_{1} + {E}_{2} {\vert}^{2} = ( {E}_{1} + {E}_{2} ) ( {{E}_{1}}^{⋆} + {{E}_{2}}^{⋆} ) = \vert {E}_{1} {\vert}^{2} + {{E}_{1}}^{⋆} {E}_{2} + {E}_{1} {{E}_{2}}^{⋆} + \vert {E}_{2} \vert 2 \qquad Equation 3$$

Note that the above-described reception electric field intensities E₁ and E₂ are complex numbers and “*” in Equation (3) denotes a complex conjugate.

Moreover, the reception electric field intensity E₁, which is a complex number, is expressed as Equation (4) when represented by amplitude A₁ and phase θ₁.

$${E}_{1} = { A}_{1} {e}^{j θ} 1 \qquad Equation 4$$

Similarly, the reception electric field intensity E₂, which is a complex number, is expressed as Equation (5) when represented by amplitude A₂ and phase θ₂.

$${E}_{2} = {A}_{2} {e}^{j θ} 2 \qquad Equation 5$$

According to Equation (4) described above, E₁*E₂ in Equation (3) is transformed into Equation (6) below.

$${{E}_{1}}^{⋆} {E}_{2} = {A}_{1} {A}_{2} {e}^{j} ( {θ}_{2} - {θ}_{1} ) \qquad Equation 6$$

Moreover, according to Equation (5) described above, E₁E₂* in Equation (3) is transformed into Equation (7) below.

$${E}_{1} {{E}_{2}}^{*} = {A}_{1} {A}_{2} {e}^{j ( {θ}_{1} - {θ}_{2} )} \qquad Equation 7$$

Note that received power generally acquired by a cellular terminal of 5G, local 5G, or the like is, for example, reference signal received power (RSRP). Since RSRP is a value averaged at a frequency, the band average of the total received power P_{T} expressed as Equation (3) described above is expressed as Equation (8) below.

$$\overline{{P}_{T}} = \overline{{\vert {E}_{1} \vert}^{2}} + \overline{{{E}_{1}}^{*} {E}_{2}} + \overline{{{E}_{1}}^{*} {E}_{2}} + \overline{{\vert {E}_{2} \vert}^{2}} \qquad Equation 8$$

Here, when the frequency is a single or narrow band, the phases of both the direct wave and the reflected wave do not vary greatly with respect to the frequency. In this case, the average value of the second term and the third term (that is, e^{j(θ2-θ1)} and e^{j(θ1-θ2)}) of the right side of Equation (8) described above vectorially has a value, so that the second term and the third term of the right side of Equation (8) are nonzero. In contrast, when the frequency is a broadband, the phases vary greatly with respect to the frequency. In this case, the addition of e^{j(θ2-θ1)} and e^{j(θ1-θ2)} vectorially approaches zero, and the second term and the third term of the right side of Equation (8) can be approximated as zero. That is, Equation (8) described above can be treated as Equation (9) below.

$${P}_{T} \approx {\vert {E}_{1} \vert}^{2} + {\vert {E}_{2} \vert}^{2} \qquad Equation 9$$

While the case in which the propagation channels between transmission and reception are two waves has been described here, the case in which the propagation channels are three waves will be assumed. The three waves include, for example, a direct wave, a reflected wave from a radio wave shielding object (relatively strong reflected wave), and a ground-reflected wave. The total received power on the reception side in this case is expressed as Equation (10) below, similarly to Equation (3) described above.

$${P}_{T} = {\vert {E}_{T} \vert}^{2} = {\vert {E}_{1} + {E}_{2} + {E}_{3} \vert}^{2} = {\vert {E}_{1} \vert}^{2} + {\vert {E}_{2} \vert}^{2} + {\vert {E}_{3} \vert}^{2} + {{E}_{1}}^{*} {E}_{2} + {E}_{1} {{E}_{2}}^{*} + {{E}_{1}}^{*} {E}_{3} + {E}_{1} {{E}_{3}}^{*} + {{E}_{2}}^{*} {E}_{3} + {E}_{2} {{E}_{3}}^{*} \qquad Equation 10$$

Equation (10) has a larger number of terms than those of Equation (3), but can be considered in the same way as in the case in which the propagation channels are two waves. Specifically, in the case of a broadband, the third and subsequent terms (that is, mutual terms) of the right side of Equation (10) are approximated as zero.

Moreover, in the case in which the propagation channels are four or more waves, assuming that the fourth and subsequent waves are scattered waves having a long path length, the fourth and subsequent waves are considered negligible because their intensities are small and have high randomness.

In view of the above, it is possible to say that Equation (11) below, which has been obtained by expanding Equation (1) on the assumption that the number of above-described dominant waves j is k, corresponds to Equation (12). Accordingly, the model of Equation (1) is considered to be theoretically explainable.

$${P}_{i} = {p}_{i 1} {C}_{1} + {p}_{i 2} {C}_{2} + … + {p}_{ik} {C}_{k} \qquad Equation 11$$

$${P}_{T} \approx {\vert {E}_{1} \vert}^{2} + {\vert {E}_{2} \vert}^{2} + … + {\vert {E}_{k} \vert}^{2} \qquad Equation 12$$

Here, the radio wave propagation environment of the estimation target position in the present embodiment changes according to the presence or absence of a radio wave shielding object between the estimation target position and the antenna 2a. In other words, the estimation of the radio wave propagation environment of the estimation target position includes the estimation of the presence or absence of a radio wave shielding object between the estimation target position and the antenna 2a.

In FIG. 8, assuming that the moving vehicle 1 moves along the route 400A in a state in which the obstacle 402, which is a radio wave shielding object, is disposed, the moving vehicle 1 receives a reflected wave from the obstacle 402 of a signal (radio wave) transmitted from the antenna 2a. In contrast, assuming that the moving vehicle 1 moves along the route 400A in a state in which the obstacle 402, which is a radio wave shielding object, is not disposed, the moving vehicle 1 does not receive a reflected wave from the obstacle 402 of a signal (radio wave) transmitted from the antenna 2a. That is, the above-described estimation of the presence or absence of a radio wave shielding object is synonymous with the estimation of the presence or absence of a reflected wave from the radio wave shielding object.

A method of estimating the presence or absence of a reflected wave from a radio wave shielding object will be described hereinafter with Equation (1) used as a start point. First, Equation (13) below, which is a matrix representation of Equation (1), is given.

$$[ \begin{matrix}{P}_{1} \\ ⋮ \\ {P}_{n}\end{matrix} ] = [ \begin{matrix}{p}_{11} & … & {p}_{1 k} \\ ⋮ & ⋱ & ⋮ \\ {p}_{n 1} & … & {p}_{nk}\end{matrix} ] [ \begin{matrix}{C}_{1} \\ ⋮ \\ {C}_{k}\end{matrix} ] \qquad Equation 13$$

In Equation (13), each row represents the elements of the position (i=1, 2, . . . , n) on the route along which the moving vehicle 1 moves, and each column represents the elements of the dominant wave (j=1, 2, . . . , k). When both sides of Equation (13) are multiplied from the left by an inverse matrix or a pseudo-inverse matrix of a matrix having power (that is, pᵢⱼ) per dominant wave at each position on the route along which the moving vehicle 1 moves as components, Equation (13) is transformed into Equation (14) below. Note that the pseudo-inverse matrix corresponds to an inverse matrix of a matrix that is not a square matrix.

$$[ \begin{matrix}{C}_{1} \\ ⋮ \\ {C}_{k}\end{matrix} ] = {[ \begin{matrix}{p}_{11} & … & {p}_{1 k} \\ ⋮ & ⋱ & ⋮ \\ {p}_{n 1} & … & {p}_{nk}\end{matrix} ]}^{- 1} [ \begin{matrix}{P}_{1} \\ ⋮ \\ {P}_{n}\end{matrix} ] \qquad Equation 14$$

Moreover, the representation of Equation (14) is modified to obtain Equation (15).

$$[ \begin{matrix}{C}_{1} \\ ⋮ \\ {C}_{k}\end{matrix} ] = [ \begin{matrix}{β}_{11} & … & {β}_{1 n} \\ ⋮ & ⋱ & ⋮ \\ {β}_{k 1} & … & {β}_{kn}\end{matrix} ] [ \begin{matrix}{P}_{1} \\ ⋮ \\ {P}_{n}\end{matrix} ] \qquad Equation 15$$

Here, when one row of Equation (15) is extracted and generalized, Equation (16) is obtained.

$${C}_{j} = {β}_{j 1} {P}_{1} + … + {β}_{jn} {P}_{n} \qquad Equation 16$$

In the present embodiment, the focus should be on the presence or absence of a reflected wave from a radio wave shielding object, and the index j indicating the reflected wave (dominant wave) from the radio wave shielding object is assumed to be 2. In this case, C₂ is defined as y, and Pᵢ is defined as explanatory variable xᵢ. Equation (16) a described above is thereby expressed as Equation (17).

$$y = {β}_{1} {x}_{1} + … + {β}_{n} {x}_{n} \qquad Equation 17$$

In Equation (17) described above, β₁, . . . , βₙ are regression coefficients, and can be calculated, based on received power (explanatory variable xᵢ) measured in a state in which the presence or absence of (the reflected wave from) the radio wave shielding object is known. In Equation (17), when (the reflected wave from) the radio wave shielding object is present, y=1, and when (the reflected wave from) the radio wave shielding object is absent, y=0.

In Equation (16) described above, even when C₁ (direct wave) and C₃ (ground-reflected wave) are defined as y, the same equation as Equation (17) is obtained. Thus, in the present embodiment, it is important to calculate regression coefficients β (β₁, . . . , βₙ) to be associated with the reflected wave from the radio wave shielding object.

In this case, in the present embodiment, Equation (17) described above is expressed as Equation (18) below, when the moving vehicle 1 moves along the route 400A illustrated in FIG. 8 m times (travels m rounds) and measures received power of each position, and the measured received power is associated with (the value of y indicating) the presence or absence of the radio wave shielding object at the time of the movement.

$$\{ \begin{matrix}{y}_{1} = {β}_{1} {x}_{11} + … + {β}_{n} {x}_{1 n} \\ {y}_{2} = {β}_{1} {x}_{21} + … + {β}_{n} {x}_{2 n} \\ ⋮ \\ {y}_{m} = {β}_{1} {x}_{m 1} + … + {β}_{n} {x}_{mn}\end{matrix} \qquad Equation 18$$

In addition, when Equation (18) is converted into a matrix, Equation (18) is expressed as Equation (19) below.

$$[ \begin{matrix}{y}_{1} \\ ⋮ \\ {y}_{m}\end{matrix} ] = [ \begin{matrix}{x}_{11} & … & {x}_{1 n} \\ ⋮ & ⋱ & ⋮ \\ {x}_{m 1} & … & {x}_{mn}\end{matrix} ] [ \begin{matrix}{β}_{1} \\ ⋮ \\ {β}_{n}\end{matrix} ] \qquad Equation 19$$

Here, when Equation (19) is expressed as Y=Xβ, components corresponding to the number of samples (number of times the moving vehicle 1 moves along the route) are set in the row direction of X and components corresponding to the number of received power measurement positions on the route are set in the column direction in Equation (19).

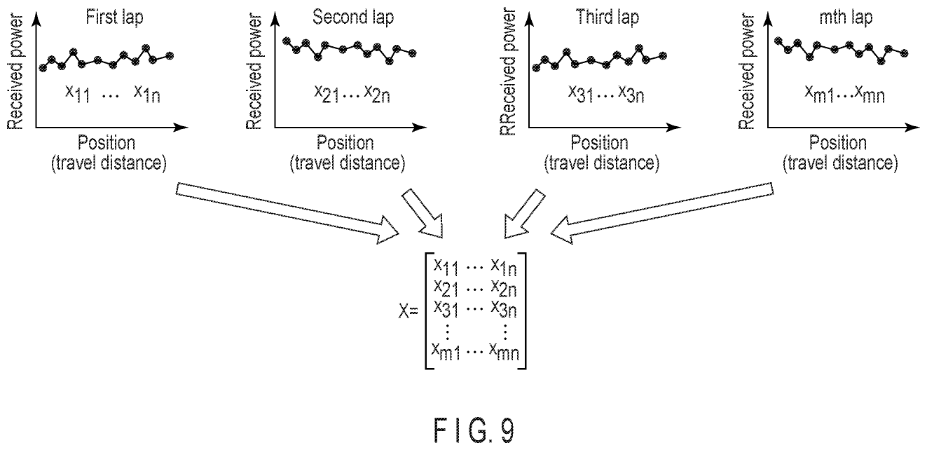

To calculate (derive) the regression coefficients β from Equation (19), received power measured at positions 1 to n on the route while the moving vehicle 1 is moving along the route m times is substituted for X as illustrated in FIG. 9. Moreover, the value (y=1 or y=0) indicating the presence or absence of the radio wave shielding object, which is known at the time of the movement along the route, is substituted for Y.

In this case, the regression coefficients β can be calculated by, for example, multiplying both sides of Equation (19) by a pseudo-inverse matrix X⁺ of the matrix X from the left. However, in the scenario assumed in the present embodiment, the focus should be on the presence or absence of the reflected wave from the radio wave shielding object, and the regression coefficients β calculated in this manner are not considered appropriate.

For this reason, in the present embodiment, partial least squares (PLS) regression is applied to calculate the regression coefficients β. In PLS regression, in consideration of both X and Y, described above, eigenvectors of X^{T}Y are derived and principal components are extracted. Note that X^{T} is a transposed matrix of the matrix X. PLS regression, in which principal components having a high correlation with Y are extracted, is considered to be appropriate for the scenario of the present embodiment, in which the focus needs to be on a specific reflected wave (that is, the reflected wave from the radio wave shielding object) only. In addition, in general, when there is a strong correlation (multicollinearity) between each column of the matrix X, the regression coefficients β become unstable. In the scenario of the present embodiment, the columns of the matrix X are composed of components corresponding to the positions on the route, respectively. Thus, depending on the radio wave propagation environment, the spatial correlation between (received power measured at) the positions may become high. However, in PLS regression, orthogonal components, that is, components having a low correlation, are extracted, so that it is possible to prevent the regression coefficients β becoming unstable under the influence of multicollinearity.

A specific calculation method of regression coefficients in PLS regression will be described here. First, matrices E and F are defined, and X and T are substituted for their initial values.

Next, E^{T}F=U_{svd}ΣV_{svd} is obtained by singular value decomposition, and the first columns of U_{svd} and V_{svd} are defined as a column vector w and a column vector c, respectively. Note that ^{T} represents a transposed matrix.

Moreover, w and c are normalized such that w^{T}w=1 and c^{T}c=1, and t and u are obtained from t=Ew and u=Fc. In addition, t and u are normalized such that t^{T}t=1 and u^{T}u=1, and p and q are obtained from p=E^{T}t and q=F^{T}t. In this way, the extraction of a first component is completed.

Then, E and F are updated by subtracting tp^{T} and tq^{T} from E and F, respectively, and the processing is repeated to extract second and subsequent components.

When an assumed number of (for example, L) components have been extracted by repeating the processing as described above, matrices T, W, P, and Q are defined as given by Equation (20) below.

$$T = [ \begin{matrix}{t}_{1} & … & {t}_{L}\end{matrix} ] \qquad Equation 20$$

$$W = [ \begin{matrix}{w}_{1} & … & {w}_{L}\end{matrix} ]$$

$$P = [ \begin{matrix}{p}_{1} & … & {p}_{L}\end{matrix} ]$$

$$Q = [ \begin{matrix}{q}_{1} & … & {q}_{L}\end{matrix} ]$$

The regression coefficients β in Equation (19) described above are calculated from Equation (21) below, using the matrices T, W, P, and Q thus defined.

$$β = {W ( {P}^{T} W )}^{- 1} \cdot {Q}^{T} \qquad Equation 21$$

In the present embodiment, the radio wave propagation environment of a factory or a warehouse in which the moving vehicle 1 moves is complicated. Assuming that a first principal component is a direct wave and a second principal component is a reflected wave, it is considered that the contribution degrees of third and subsequent principal components are lower than those of the first and second principal components and include noise components, although precise classification is difficult. For this reason, the number of components extracted in PLS is basically two as described above.

In the present embodiment, as described above, the regression coefficients can be calculated, using received power measured at each position on the route in a state in which the presence or absence of a radio wave shielding object is known (that is, a state in which the radio wave shielding object is disposed and a state in which the radio wave shielding object is not disposed). In the present embodiment, calculating (deriving) the regression coefficients in this manner is referred to as learning.

In the present embodiment, to estimate the presence or absence of a radio wave shielding object (radio wave propagation environment) at the time of the operation of the moving vehicle control system, the regression coefficients (β₁, . . . , βₙ) calculated through the learning are multiplied by received power (x₁, . . . , xₙ) newly measured on the same route, as given by Equation (22) below.

$$y = {β}_{1} {x}_{1} + … + {β}_{n} {x}_{n} \qquad Equation 22$$

The value of y calculated from Equation (22) described above corresponds to a value indicating the presence or absence of a radio wave shielding object, and the presence or absence of a radio wave shielding object can be estimated (analogized) by comparing the value of y with a threshold value.

The coefficients in the present embodiment may be acquired, using a learned model generated by learning received power measured at each position on the route in a state in which the presence or absence of a radio wave shielding object is known, for example, on the basis of a technology called artificial intelligence (AI).

The operation of the information processing apparatus 3 according to the present embodiment will be described hereinafter. Here, the processing of the information processing apparatus 3 executed to calculate the above-described regression coefficients (hereinafter, referred to as learning processing) and the processing of the information processing apparatus 3 executed to estimate the presence or absence of a radio wave shielding object (environmental state of radio wave shielding) (hereinafter, referred to as estimation processing) will be described.

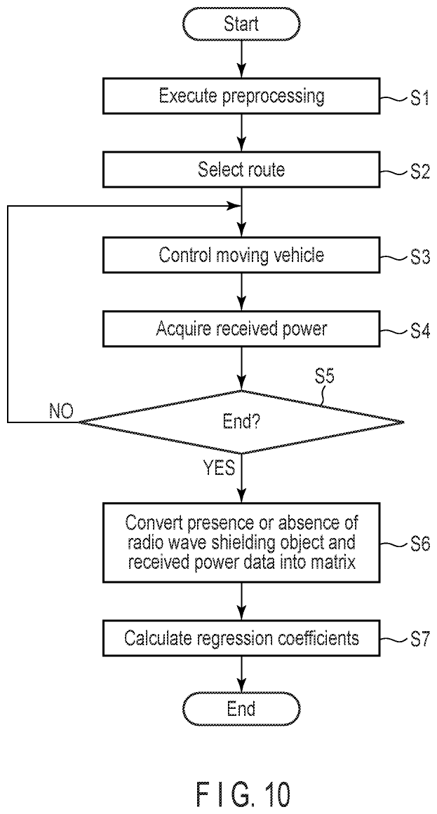

First, an example of a processing procedure of the above-described learning processing will be described with reference to the flowchart of FIG. 10.

In the learning processing, the processing of generating map data and a received power map is executed as preprocessing (preparation) for calculating the regression coefficients (step S1).

First, the processing of generating the map data will be described. When the target space (environment) is a space that is static to a certain degree, it is sufficient that fixed map data indicating a map of the target space is prepared. However, in the above-described target space, such as a factory or a warehouse, the arrangement of obstacles (loads such as cardboard boxes) changes with time, and the map data needs to be generated (updated) dynamically.

In this case, the processor 31 (control module 31f) included in the information processing apparatus 3 generates a control signal for controlling the moving vehicle 1 such that the moving vehicle 1 moves through the entire range in which the moving vehicle 1 can move in the target space. The control signal (downlink) thus generated in the processor 31 is output from the processor 31 (output module 31g) to the base station 2 and is transmitted from the base station 2 to the moving vehicle 1. In this case, the control signal is received by the reception module 11 included in the moving vehicle 1, and the control module 12 controls the moving speed and direction of the moving vehicle 1, based on the control signal. The moving vehicle 1 thereby moves through the entire target space.

Here, the distance measurement module 13 included in the moving vehicle 1 measures TOF by an LRF or the like, and thereby measures the distance to an object (for example, a wall and an obstacle) existing around the moving vehicle 1 moving in the target space.

The transmission module 15 transmits data for map generation (uplink) including the distance thus measured by the distance measurement module 13 and the moving speed and direction of the moving vehicle 1 controlled by the control module 12 to the information processing apparatus 3 via the base station 2. The data for map generation is transmitted to the information processing apparatus 3, for example, whenever the moving vehicle 1 moves based on a control signal (that is, for each position in the target space).

As described above, the data for map generation transmitted from the moving vehicle 1 (transmission module 15) is received by the base station 2 and is output to the information processing apparatus 3. The processor 31 (acquisition module 31a) included in the information processing apparatus 3 acquires the data for map generation output from the base station 2. The processor 31 (map data generation module 31b) generates map data indicating a map of the target space, based on the distance and the moving speed and direction of the moving vehicle 1 included in the acquired data for map generation. The map data thus generated by the processor 31 is data indicating a map such as a plan view illustrating a wall forming the target space, a passage along which the moving vehicle 1 can move, an obstacle disposed in the target space, and the like.

Note that the map data may be generated by, for example, updating the initial layout of the target space in which an obstacle and the like are not disposed (map data indicating only the wall and the passage).

The map data generated by the processor 31 (map data generation module 31b) as described above is stored in the storage 32.

The processing of generating the received power map will be described next. In this case, the processor 31 (control module 31f) included in the information processing apparatus 3 generates a control signal for controlling the moving vehicle 1 such that the moving vehicle 1 moves along all the passages on the map indicated by the map data stored in the storage 32 as described above. The control signal thus generated in the processor 31 is output from the processor 31 (output module 31g) to the base station 2 and is transmitted from the base station 2 to the moving vehicle 1. The moving vehicle 1 thereby moves through the entire target space.

Here, in 5G (local 5G), a synchronization signal is broadcasted from the base station 2. The reception module 11 included in the moving vehicle 1 receives the synchronization signal thus broadcasted from the base station 2.

The received power measurement module 14 measures the received power of the synchronization signal received by the reception module 11. As the received power measured in the present embodiment, reference signal received power (RSRP) is used, for example. However, the received power may be, for example, a received signal strength indicator (RSSI), secondary synchronization signal-reference signal received power (SSS-RSRP), primary synchronization signal-reference signal received power (PSS-RSRP), or the like.

In addition, it has been here explained that the received power of the synchronization signal broadcasted from the base station 2 is measured. For example, in 5G (local 5G), a plurality of reference signals such as a channel state information-reference signal (CSI-RS), which is a reference signal for channel information estimation, and a demodulation reference signal (DM-RS), which is a reference signal for demodulation, are prepared. Therefore, the received power may be measured using these reference signals. In this case, the received power of one reference signal of reference signals differing in at least one of frequency, time, and antenna may be measured, or an average value of the received power of the reference signals may be measured.

The transmission module 15 transmits received power data indicating the received power thus measured by the received power measurement module 14 to the information processing apparatus 3 via the base station 2. The received power data is transmitted to the information processing apparatus 3, for example, whenever the moving vehicle 1 moves based on a control signal (for each point in the target space).

Moreover, in the processing of generating the received power map, too, the above-described data for map generation (the distance to an object existing around the moving vehicle 1 and the moving speed and direction of the moving vehicle 1) is transmitted from the moving vehicle 1 to the information processing apparatus 3, whenever the moving vehicle 1 moves, the detailed description of which is omitted here.

The data for map generation and the received power data transmitted from the moving vehicle 1 (transmission module 15) as described above is received by the base station 2 and is output to the information processing apparatus 3. The processor 31 (acquisition module 31a) included in the information processing apparatus 3 acquires the data for map generation and the received power data output from the base station 2.

Here, the processor 31 can acquire (grasp) the position of the moving vehicle 1 on the map indicated by the map data, based on the distance to an object existing around the moving vehicle 1 and the moving speed and direction of the moving vehicle 1 included in the data for map generation. The processor 31 (received power map generation module 31c) generates a received power map (heat map of the received power at each position of the moving vehicle 1) obtained by mapping the position of the moving vehicle 1 thus acquired and the received power indicated by the received power data. Specifically, the processor 31 generates the received power map by allocating the received power measured at each position by the movement of the moving vehicle 1 to (pixels corresponding to) the positions (that is, associating the positions with the received power). The received power map thus generated corresponds to a radio wave map indicating the radio wave propagation environment in the target space. When a human intervenes in the control on the information processing apparatus 3 (MEC) side, a received power map in a visually recognizable form may be generated.

The received power map generated by the processor 31 (received power map generation module 31c) as described above is stored in the storage 32.

In the processing of generating the received power map, the data for map generation is used to acquire the positions to be allocated to the received power indicated by the received power data, whereas the data for map generation also can be used to update the above-described map data (that is, the arrangement of an obstacle and the like) stored in the storage 32.

In addition, it has been explained here that the received power map is generated based on the received power of a downlink signal (synchronization signal). However, since there is duality (symmetrical relationship) between the downlink and the uplink in wireless communication in general, the received power map may be generated based on the received power of an uplink signal, or may be generated based on the result of the merging of the received power of a downlink signal and the received power of an uplink signal.

In the present embodiment, the processing of generating the map data and the processing of generating the received power map have been explained separately (that is, it has been explained that the map data is generated and then the received power map is generated). However, the map data and the received power map may be generated at the same time (in parallel).

In addition, in the present embodiment, a map in which the signal throughput or bit error rate of a signal is allocated to each position on the map may be generated instead of the received power map, as long as the radio wave (signal) propagation environment in the target space can be grasped.

Moreover, for example, when an obstacle (for example, a radio wave shielding object) disposed in the target space is known, information such as the position of the obstacle grasped by premeasurement or the like may be registered (held) in the map data and the received power map.

When the processing of step S1 is executed, the processor 31 (control module 31f) included in the information processing apparatus 3 selects a route including a received power measurement position at which the moving vehicle 1 measures received power to calculate a regression coefficient (step S2). The received power measurement position included in the route selected in step S2 is a position that is within the line of sight from the antenna 2a even when a radio wave shielding object is disposed (that is, a position with no radio wave shielding object disposed between the antenna 2a and the position). In the present embodiment, the regression coefficient which associates the received power measured at the received power measurement position with the radio wave propagation environment of the estimation target position which is excluded from the line of sight from the antenna 2a by the disposition of the radio wave shielding object is calculated.

In step S2, for example, a route may be automatically selected based on the position at which the radio wave shielding object is disposed or the position at which the radio wave shielding object may be disposed, or a route specified by an administrator of the moving vehicle control system may be selected.

Specifically, in the case of the target space illustrated in FIG. 8, the route 400A including a position within the line of sight from the antenna 2a, for example, is selected in step S2.

When the processing of step S2 is executed, the processor 31 (control module 31f) controls the moving vehicle 1 such that the moving vehicle 1 moves along the route selected in step S2 in a state in which the presence or absence of the radio wave shielding object is known (step S3). The control of the moving vehicle 1 in step S3 is executed through the output of a control signal for controlling the moving vehicle 1 generated by the processor 31 to the base station 2 and the transmission of the control signal from the base station 2 to the moving vehicle 1.

Here, when the above-described processing of step S3 is executed, the moving vehicle 1 moves along the route selected in step S2, and the moving vehicle 1 transmits received power data indicating received power measured at each position during the movement to the information processing apparatus 3 via the base station 2.

In this case, the processor 31 (acquisition module 31a) included in the information processing apparatus 3 acquires the received power data transmitted from the moving vehicle 1 moving along the route selected in step S2 from the base station 2 (step S4). The received power data acquired in step S4 (that is, the received power measured by the moving vehicle 1) is allocated to (held in) the received power map.

Next, it is determined whether the movement of the moving vehicle 1 is to be ended (step S5). In the present embodiment, the regression coefficients are calculated, using received power measured by causing the moving vehicle 1 to move more than once (travel more than one round) along the same route. Thus, when the moving vehicle 1 has moved along the route selected in step S2 a predetermined number of times, it is determined in step S5 that the movement of the moving vehicle 1 is to be ended. In contrast, when the moving vehicle 1 has not moved along the route the predetermined number of times, it is determined in step S5 that the movement of the moving vehicle 1 is not to be ended. As described above, the number of moving vehicles 1 moving along the route the predetermined number of times may be one or may be more than one.

In the present embodiment, the moving vehicle 1 moves repeatedly in a state in which the presence or absence of the radio wave shielding object is known, and it is preferable that the presence or absence of the radio wave shielding object be changed while the moving vehicle 1 is moving repeatedly along the same route. This enables the calculation of highly accurate regression coefficients, based on both the received power measured in a state in which the radio wave shielding object is disposed and the received power measured in a state in which the radio wave shielding object is not disposed.

When it is determined that the movement of the moving vehicle 1 is not to be ended (NO in step S5), the flow returns to step S3 and the processing is repeated.

In contrast, when it is determined that the movement of the moving vehicle 1 is to be ended (YES in step S5), the processor 31 (calculation module 31d) executes the processing of calculating the regression coefficients which associate the received power data acquired in step S4 (that is, the received power allocated to each position in the received power map) with the radio wave propagation environment of the estimation target position (that is, the value indicating the presence or absence of the radio wave shielding object).

In this case, the processor 31 acquires the received power measured by the movement of the moving vehicle 1 along the route selected in step S2 from the received power map, and converts (the value indicating) the presence or absence of the radio wave shielding object at the time of the movement along the route and the acquired received power into a matrix (step S6).

The processing of step S6 will be described in detail hereinafter. First, in the present embodiment, the presence or absence of the radio wave shielding object when the moving vehicle 1 moves along the route selected in step S2 (that is, the received power is measured) is known as described above. Thus, the presence or absence of the radio wave shielding object for each movement (round) along the route by the moving vehicle 1 is substituted for Y (y₁, . . . , yₘ) of Equation (19) described above. Specifically, for example, when the radio wave shielding object is disposed at the time of the movement along the route for the first time by the moving vehicle 1, 1 is substituted for y₁ of Y of Equation (19). In addition, for example, when the radio wave shielding object is not disposed at the time of the movement for the mth time by the moving vehicle 1, 0 is substituted for yₘ of Y of Equation (19).

While it has been explained here that the presence or absence of the radio wave shielding object is expressed quantitatively as y=1 and y=0, the value of y when the radio wave shielding object is present may be expressed by a decimal, for example, y=0.6 or y=0.4, in accordance with the radio wave shielding degree of the radio wave shielding object. The same applies to the value of y when the radio wave shielding object is absent.

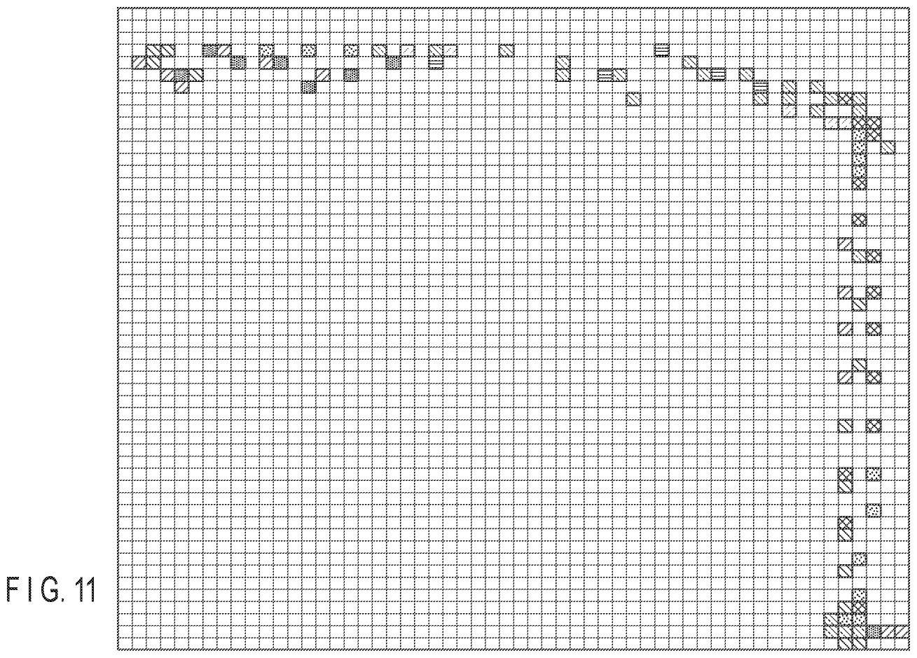

FIG. 11 illustrates an example of the received power map. Note that FIG. 11 corresponds to part of the received power map.

In step S6, the received power measured at each received power measurement position whenever the moving vehicle 1 moves along the route 400A is acquired from the received power map as illustrated in FIG. 11, and the received power is substituted for X (x₁₁, . . . , xₘₙ) of Equation (19).

Note that the received power acquired from the received power map may be considered as a power spectrum and the received power may be converted from a decibel value to a linear value to be substituted for X of Equation (19).

In addition, the received power substituted for X of Equation (19) may be part of the received power held in the received power map. Specifically, for example, the received power measured near the obstacle 402 illustrated in FIG. 8 is considered to be easily influenced by the radio wave shielding object (that is, a change in a reflected wave is easily detected). Thus, not all the received power measured at each position on the route 400A from the start point to the goal point, but only the received power measured near the obstacle 402 (that is, part of the route 400A) (that is, received power near the radio wave shielding object) may be substituted for X of Equation (19).

When the processing of step S6 is executed, the processor 31 calculates regression coefficients β (β₁, . . . , βₙ), based on Equation (19), in which the known presence or absence of the radio wave shielding object has been substituted for Y (y₁, . . . , yₘ) and the received power acquired from the received power map has been substituted for X (x₁₁, . . . , xₘₙ) as described above (hereinafter, referred to as learning data) (step S7). Since Equation (19) conforms to the theory of Equations (1) to (12) described above, the above-described learning data enables the calculation of excellent regression coefficients for estimating the presence or absence of the radio wave shielding object (that is, the radio wave propagation environment of the estimation target position).

In the calculation of the regression coefficients in step S7, PLS regression is used. As described above, in PLS regression, orthogonal components (that is, components having a low correlation) are extracted, so that the influence of multicollinearity can be suppressed.

As described above, the regression coefficients calculated in step S7 are used for the estimation processing, which will be described later, and are thus held in the processor 31 (estimation module 31e).

Incidentally, while the received power acquired from the received power map is substituted in Equation (19) in step S6, the received power may be acquired from the received power map based on reference positions set on the route in advance.

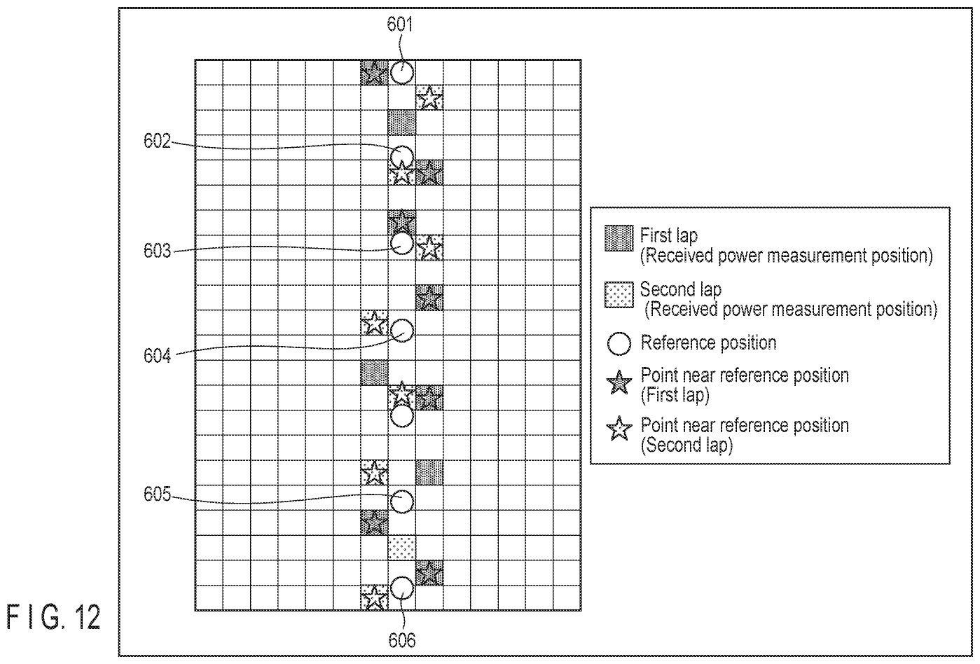

The above-described reference positions will be described hereinafter with reference to FIG. 12. FIG. 12 illustrates the reference positions set on the route along which the moving vehicle 1 moves, and the received power measurement positions at the time of the movement along the route for the first time and the received power measurement positions at the time of the movement along the route for the second time.

In the present embodiment, as illustrated in FIG. 12, for example, received power measured near the reference positions (specifically, at positions within a predetermined range set based on the reference positions, and more specifically, at positions at a distance within a predetermined value from the reference positions) may be substituted for X of Equation (19).

Specifically, in the example illustrated in FIG. 12, reference positions 601 to 606 are set on the route. In this case, of the received power measured at the time of the movement along the route for the first time, received power measured at the respective points near the reference positions 601 to 606 is substituted for X of Equation (19). Similarly, of the received power measured at the time of the movement along the route for the second time, received power measured at the respective points near the reference positions 601 to 606 is substituted for X of Equation (19). In FIG. 12, the received power measurement positions at which the received power substituted for X of Equation (19) (that is, the received power acquired from the received power map) have been measured are marked with stars.

As illustrated in FIG. 12, even when the moving vehicle 1 moves along the same route more than once, the positions through which the moving vehicle 1 moves (travels) and the received power measurement positions shift whenever the moving vehicle 1 moves. However, setting the reference positions for acquiring (selecting) the received power to be substituted for X of Equation (19) as described above can prevent the regression coefficients from being calculated using received power at greatly different received power measurement positions (that is, the accuracy of the regression coefficients from deteriorating). In addition, the number of pieces of received power data for each movement (round) along the route to be substituted for X of Equation (19) (the number of components in the column direction) can be equalized by using the above-described reference positions.

Note that the above-described reference positions may be set at regular intervals or may be set at irregular intervals (different intervals).

Here, the regression coefficients β calculated in the present embodiment include regression coefficients β₁, . . . , βₙ as expressed in Equation (19). In other words, it is possible to say that in the present embodiment, the regression coefficients β (β₁, . . . , βₙ) corresponding to the positions (received power measurement positions) on the route are calculated.

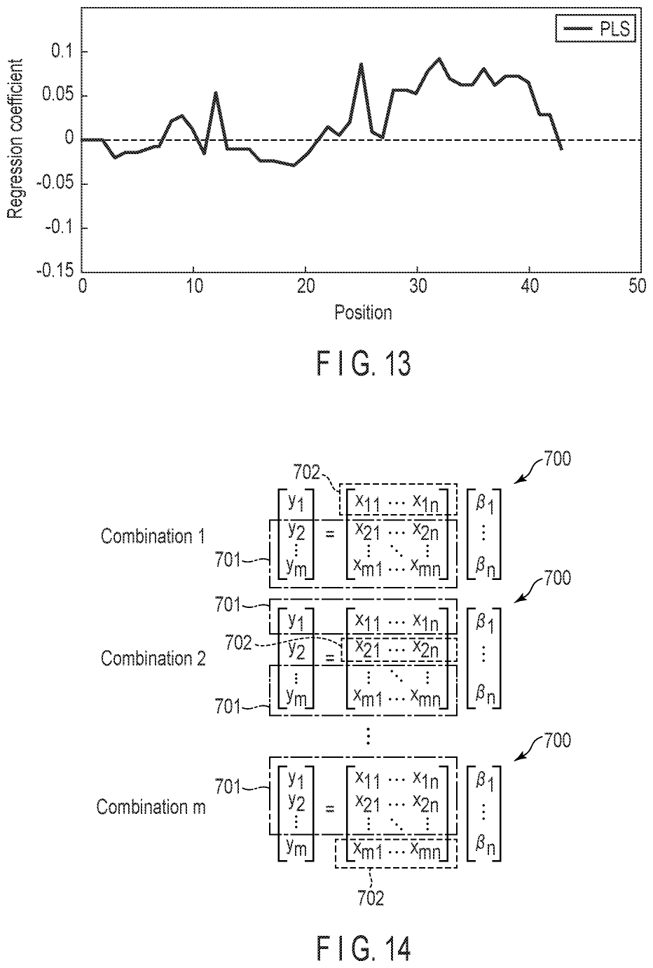

FIG. 13 illustrates an example of the regression coefficients β (β₁, . . . , βₙ) corresponding to the positions calculated by applying PLS regression to the above-described learning data including the received power measured at part of the route 400A illustrated in FIG. 8 (Equation (19), in which the received power has been substituted for X). It is assumed that the received power used to calculate the regression coefficients β illustrated in FIG. 13 (the received power included in the learning data) have been measured in a state in which the radio wave shielding object (obstacle 402) is disposed.

In the example illustrated in FIG. 13, for example, the position i=30 to 40 represents positions near the radio wave shielding object on the route 400A illustrated in FIG. 8, and the regression coefficients β (β₃₀ to β₄₀) corresponding to these positions are positive values.

In the case of the regression coefficients β being calculated on the assumption that that y=1 when the radio wave shielding object is present and y=0 when the radio wave shielding object is absent as described above, the regression coefficients β corresponding to the positions near the radio wave shielding object are positive values so that the value of y in Equation (22) described above approaches 1. In other words, the positions at which the regression coefficients β that are positive values have been calculated are considered to be positions especially close to the radio wave shielding object, that is, positions strongly influenced by a reflected wave from the radio wave shielding object.

Thus, in the present embodiment, the above-described reference positions may be set based on, for example, the positions at which the regression coefficients β are positive values (the positions estimated to be near the radio wave shielding object). In this case, it is sufficient that, for example, the regression coefficients β are calculated once, and then the reference positions are set with reference to the positions at which the regression coefficients β are positive values to calculate the regression coefficients β again.

Moreover, even when the received power measured at the above-described positions near the radio wave shielding object is used, the accuracy of the regression coefficients β may vary depending on the reference positions. Thus, in the present embodiment, cross-validation may be adopted to optimize the reference positions.

Here, when cross-validation is applied to the present embodiment, part of Equation (19), in which the presence or absence of the radio wave shielding object has been substituted for Y and the received power has been substituted for X in step S6 described above, (that is, the learning data) is used as test data for evaluating the regression coefficients β calculated using the learning data.

Specifically, as illustrated in FIG. 14, learning data 700 is divided into, for example, learning data 701 including the presence or absence of the radio wave shielding object and the received power during the movement along the route for the second time to the mth time, and test data 702 including the received power during the movement along the route for the first time. This combination of the learning data 701 and the test data 702 will be referred to as Combination 1.

Similarly, the learning data 700 is divided into, for example, learning data 701 including the presence or absence of the radio wave shielding object and the received power during the movement along the route for the first time and the third to mth times, and test data 702 including the received power during the movement along the route for the second time. This combination of the learning data and the test data will be referred to as Combination 2.

Combinations 1 to m of the learning data 701 and the test data 702 can be prepared by changing the test data 702 used to evaluate the regression coefficients β in the learning data 700 in this manner.

Here, in the cross-validation of the present embodiment, the presence or absence of the radio wave shielding object corresponding to the test data 702 in Combinations 1 to m (that is, the presence or absence of the radio wave shielding object at the time of the measurement of the received power included in the test data 702) can be used as correct data. Thus, (the estimation accuracy of) the regression coefficients β can be evaluated by comparing the value of y calculated using the regression coefficients β, which have been calculated using the learning data 701, and the test data 702, with the correct data in each of Combinations 1 to m.

Accordingly, the reference positions can be optimized (that is, the optimum reference positions can be selected) according to the estimation accuracy by assigning candidates for the reference positions as parameters and evaluating the estimation accuracy of each of the parameters by cross-validation.

While it has been explained that one route is selected in step S2 illustrated in FIG. 10, a plurality of routes may be selected in step S2. In this case, it is sufficient that regression coefficients are calculated for each route by executing the processing of steps S3 to S7 for each route selected in step S2.

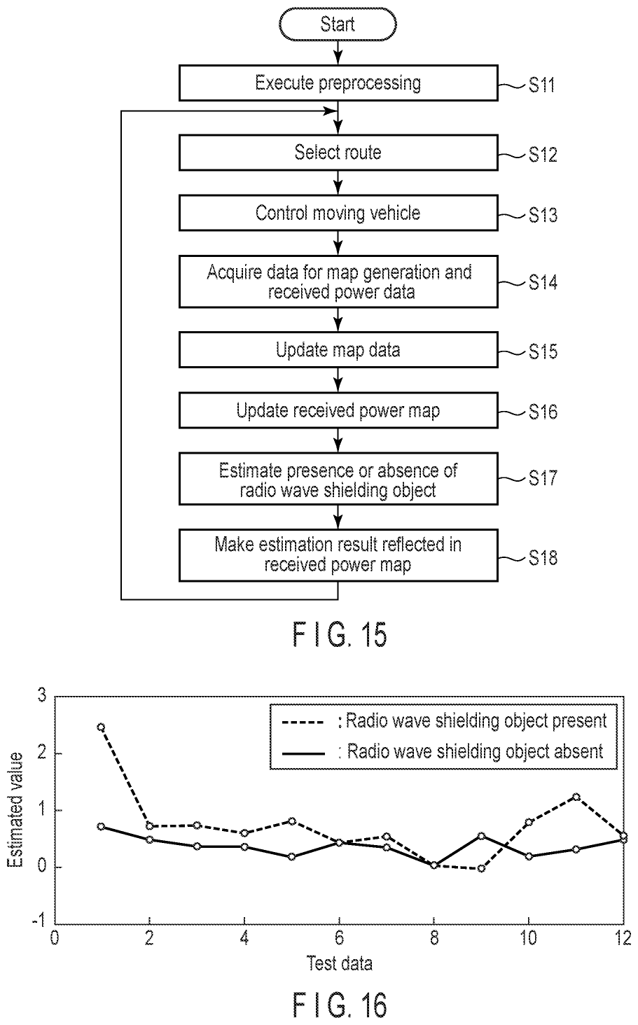

An example of a processing procedure of the estimation processing will be described next with reference to the flowchart of FIG. 15.

In the estimation processing, map data and a received power map are generated by executing the processing of step S11 corresponding to the above-described processing of step S1 illustrated in FIG. 10 as preprocessing (preparation) for estimating the presence or absence of the radio wave shielding object. The map data and the received power map thus generated are stored in the storage 32.

When the map data and the received power map generated in the above-described processing illustrated in FIG. 10 can be used in the estimation processing, the processing of step S11 may be omitted.

When the processing of step S11 is executed, the operation of the moving vehicle control system can be started. In this case, the processor (control module 31f) included in the information processing apparatus 3 selects a route along which the moving vehicle 1 moves in the target space, based on the map data and the received power map stored in the storage 32 (step S12).

In step S12, the processor 31, for example, performs cost calculation of each route from a start point to a goal point set on a map indicated by the map data in consideration of received power at positions (spaces) overlapping the routes, and selects an optimum route from the routes based on the result of the cost calculation.

The cost calculation for selecting the route will be briefly described hereinafter. First, the processor 31 refers to the received power map and acquires received power allocated to each position (pixel) corresponding to each of the routes (the shortest route, the intermediate route, the longest route, and the like) from the start point to the goal point. The processor 31 classifies the acquired received power into “strong”, “medium”, and “weak”, based on threshold values prepared in advance. In this case, for example, assuming that the value (cost) corresponding to “strong” is 1, the value (cost) corresponding to “medium” is 2, and the value (cost) corresponding to “weak” is 3, the processor 31 calculates the cost of each route by adding the values corresponding to the results (“strong”, “medium”, and “weak”) into which the received power allocated to each position corresponding to each route has been classified, for each route. The processor 31 selects, for example, the route with which the cost thus calculated is the lowest.

According to the cost calculation like this, for example, when an insensitive area (zone in which received power deteriorates) does not occur in the target space, the cost of the shortest route is the lowest, so that the shortest route is selected. In contrast, for example, when the insensitive area occurs on the shortest route, the cost of the shortest route increases, so that the intermediate route is selected, for example. Moreover, when the insensitive area occurs on the shortest route and the intermediate route, the longest route is selected, for example.

For example, it is conceivable that the deterioration of received power in the insensitive area is suppressed by using time diversity, frequency diversity, or spatial diversity. However, in the present embodiment, a route avoiding the insensitive area is selected with priority given to the more stable operation (movement) of the moving vehicle 1.

When the processing of step S12 is executed, the processor 31 (control module 31f) controls the moving vehicle 1 such that the moving vehicle 1 moves along the route selected in step S12 (step S13). The processing of step S13 is the same as the above-described processing of step S3 illustrated in FIG. 10, and thus, its detailed description is omitted here.

Here, when the above-described processing of step S13 is executed, the moving vehicle 1 moves along the route selected in step S12 from the start point to the goal point, and the moving vehicle 1 transmits the above-described data for map generation and received power data to the information processing apparatus 3 via the base station 2 at each position during the movement.

In this case, the processor 31 (acquisition module 31a) included in the information processing apparatus 3 acquires the data for map generation and the received power data transmitted from the moving vehicle 1 moving along the route selected in step S12 from the base station 2 (step S14).

When the processing of step S14 is executed, the processor 31 (map data generation module 31b) updates the map data stored in the storage 32, based on the data for map generation acquired in step S14 (step S15). Since only the data for map generation on the route selected in step S12 is acquired in step S14, only the portion near the route of the map indicated by the map data is updated in step S15.

Moreover, the processor 31 (received power map generation module 31c) updates the received power map stored in the storage 32, based on the data for map generation and the received power data acquired in step S14 (step S16).

Here, assuming that such a route as avoids the insensitive area (for example, the route 400A illustrated in FIG. 8) is selected in step S12 described above, only the data for map generation and the received power data on the route are acquired in step S14. Thus, in step S16, only the received power allocated to each position on the route that avoids the insensitive area of the received power map is updated.

That is, in the received power map updated in step S16 described above, it is impossible to grasp whether the insensitive area on the route along which the moving vehicle 1 has not moved becomes sensitive.

The insensitive area becomes sensitive by, for example, removing the radio wave shielding object, but there is a possibility that the moving vehicle 1 in the present embodiment can detect the presence or absence of an obstacle disposed in the target space by an LRF. However, since the LRF cannot determine, for example, the height of the obstacle, the insensitive area may become sensitive, for example, when the height of the obstacle detected by the LRF is small. Moreover, for example, in the case in which the obstacle detected by the LRF is not the radio wave shielding object, the insensitive area may become sensitive even when the obstacle is detected. That is, it is hard for the LRF to estimate the sensitivity of the insensitive area (that is, the state of radio wave shielding in the environment including the position where the moving vehicle 1 has not moved).

Thus, in the present embodiment, the processor 31 (estimation module 31e) estimates the presence or absence of the radio wave shielding object which influences the radio wave propagation environment of the estimation target position different from the received power measurement positions at which the moving vehicle 1 has measured received power (that is, the radio wave shielding object between the antenna 2a and the estimation target position), using the regression coefficients calculated by executing the above-described learning processing (the regression coefficients held in the processor 31) and the received power measured by the moving vehicle 1 moving along the route selected in step S12 (step S17).

It is assumed that the route selected in step S12 is the same route as the above-described route selected in step S12 illustrated in FIG. 10 (that is, the route along which the regression coefficients have been calculated).

The processing of step S17 will be described hereinafter. In step S17, the processor 31 acquires the received power measured at each position on the route by the movement along the route selected in step S12 from the received power map.

As described above, even when the moving vehicle 1 moves along the same route, the positions through which the moving vehicle 1 moves (travels) and the received power measurement positions shift whenever the moving vehicle 1 moves, and the regression coefficients β have been calculated in a state in which they shift. Thus, it is sufficient that the received power acquired from the received power map to execute the processing of step S17 as described above is measured at received power measurement positions corresponding to the received power measurement positions at which the received power acquired from the received power map to execute the above-described processing of step S6 illustrated in FIG. 10 has been measured, and the positions need not be completely consistent with each other. Specifically, when the received power measured at points near the reference positions has been acquired to execute the processing of step S6 illustrated in FIG. 10, it is sufficient that the received power measured at points near the reference positions is similarly acquired also in step S17.

Next, in step S17, the processor 31 calculates the value of y (hereinafter, referred to as an estimated value) by substituting the regression coefficients (β₁, . . . , βₙ) held in the processor 31 and the received power (x₁, . . . , xₙ) acquired as described above in Equation (22), and estimates the presence or absence of the radio wave shielding object, based on the calculated estimated value.

Here, the presence or absence of the radio wave shielding object can be estimated (determined) by the magnitude of the estimated value with respect to a threshold value. For example, in the case in which the regression coefficients are calculated on the assumption that y=1 when the radio wave shielding object is present and y=0 when the radio wave shielding object is absent as described above, 0.5 is set as the threshold value, for example. Accordingly, the processor 31 can estimate the radio wave shielding object to be present when the estimated value is greater than or equal to 0.5, and can estimate the radio wave shielding object to be absent when the estimated value is less than 0.5.

When the processing of step S17 is executed, the processor 31 (control module 31f) makes the estimation result of the presence or absence of the radio wave shielding object in step S17 reflected in the received power map stored in the storage 32 (step S18). Specifically, when the radio wave shielding object is estimated to be absent in step S17 described above, the radio wave propagation environment of the estimation target position is considered to be changed (that is, the propagation environment is considered excellent) in step S18, and the processing of updating the received power map is executed to increase the received power allocated to the estimation target position (that is, the position excluded from the line of sight from the antenna 2a by the radio wave shielding object in a state in which the radio wave shielding object is disposed). In contrast, when the radio wave shielding object is estimated to be present in step S17, the state of radio wave shielding in the environment including the estimation target position is considered to be unimproved (that is, the state is considered poor) in step S18, and the received power map is not updated.

When the above-described processing of step S18 is executed, the flow returns to step S12 and the processing is repeated. In this way, for example, when the insensitive area occurs on the route along which the moving vehicle 1 has moved because the radio wave shielding object is newly disposed, a route avoiding the insensitive area is selected, based on the received power map updated in step S16 according to the deterioration of the received power in the insensitive area. In addition, in the case in which such a route as avoids the insensitive area generated by the radio wave shielding object has been selected in step S12 described above, when the radio wave shielding object is estimated to be absent (the radio wave propagation environment of the estimation target position is estimated to be changed) in step S17, a route including the estimation target position can be selected based on the received power map, in which the estimation result is reflected, in step S18. In contrast, when the radio wave shielding object is estimated to be present in step S17, the received power map is not updated, the received power of the estimation target position remains low, so that it is possible to avoid selecting the above-described route including the estimation target position.

That is, in the present embodiment, the processor 31 (control module 31f) can control the moving vehicle 1 while selecting an appropriate route, based on the above-described estimation result of the state of radio wave shielding (presence or absence of the radio wave shielding object).

In FIG. 15, for example, a situation in which the moving vehicle 1 moves repeatedly along the route from the start point to the goal point set on the map indicated by the map data has been assumed. In this situation, it is sufficient that the processing illustrated in FIG. 15 is ended, for example, at the timing at which the predetermined control of the moving vehicle 1 (that is, the conveyance of a load by the moving vehicle 1 or the like) is ended.

In addition, it has been explained that in step S18, when the radio wave shielding object is estimated to be absent, the received power map is updated to increase the received power allocated to the estimation target position. However, the received power map may be updated to delete the received power information allocated to the estimation target position. This enables the selection of a route including the estimation target position by performing cost calculation such that the cost is 0 at the locations without received power information.

Moreover, it has been explained that in the processing illustrated in FIG. 15, the received power map is updated based on the estimation result of the presence or absence of the radio wave shielding object in step S17. However, it is sufficient that the estimation result is used to control the moving vehicle 1 (for example, to select a route or the like). In addition, the estimation result of the presence or absence of the radio wave shielding object in step S17 may be used in other processing, or may be output from the information processing apparatus 3 to an external apparatus to be used in the processing executed in the external apparatus.

A specific example of the operation of the information processing apparatus 3 at the time of the estimation processing will be described hereinafter with reference to the above-described example illustrated in FIG. 8. Here, it is assumed that the above-described learning processing has already been executed and regression coefficients have been calculated, based on the received power measured by moving the moving vehicle 1 repeatedly along the route 400A illustrated in FIG. 8 in a state in which the obstacle 402, which is the radio wave shielding object, is disposed and a state in which the obstacle 402 is not disposed.

First, map data and a received power map are generated by moving the moving vehicle 1 in the target space illustrated in FIG. 8. Here, it is assumed that the obstacle 402, which is the radio wave shielding object, is not disposed and no insensitive area occurs in the target space (the radio wave propagation environment in the target space is excellent).

Next, the route along which the moving vehicle 1 moves is selected, based on the above-described map data and received power map. Here, the route 400B is the shortest route compared to the route 400A, and the route 400B is assumed to be selected.

When the route 400B is selected as described above, the moving vehicle 1 is controlled to move (carry a load) from the start point to the goal point along the route 400B.

Note that the moving vehicle 1 transmits data for map generation and received power data at each position on the route 400B while moving along the route 400B. In this case, the map data and the received power map are updated, based on the data for map generation and the received power data transmitted from the moving vehicle 1.

Here, it is assumed that the obstacle 402 is disposed while the moving vehicle 1 is moving along the route 400B. In this case, the insensitive area occurs at a position facing the antenna 2a with the obstacle 402 interposed therebetween (behind the obstacle 402 when viewed from the antenna 2a), and the received power map is updated to allocate deteriorated received power to the position.

According to the received power map like this, the route 400A avoiding the insensitive area is selected as the route along which the moving vehicle 1 moves, and the moving vehicle 1 is controlled to move from the start point to the goal point along the route 400A.

The moving vehicle 1 transmits data for map generation and received power data at each position on the route 400A while moving along the route 400A. In this case, the map data and the received power map are updated, based on the data for map generation and the received power data transmitted from the moving vehicle 1.

Here, the presence or absence of the radio wave shielding object (here, the obstacle 402) is estimated, based on the regression coefficients calculated based on the received power measured by moving repeatedly along the route 400A at the time of the learning processing as described above, and the received power measured by the moving vehicle 1 moving along the route 400A at the time of the estimation processing (that is, at the time of the operation of the moving vehicle control system).

When the estimation result shows that the radio wave shielding object is present, the estimation target position (that is, the position on the route 400B) excluded from the line of sight from the antenna 2a by the radio wave shielding object is considered to be the insensitive area, and the route 400A along which the moving vehicle 1 has been moving is not changed (that is, the moving vehicle 1 is controlled to continuously move along the route 400A).

In contrast, when the estimation result shows that the radio wave shielding object is absent, the estimation target position is considered to be not the insensitive area (the insensitive area occurring at the estimation target position is considered to be eliminated), and the route 400A along which the moving vehicle 1 has been moving is changed to the route 400B (that is, the moving vehicle 1 is controlled to move along the route 400B).

As described above, in the present embodiment, received power (first received power) measured by the moving vehicle 1 is acquired at a received power measurement position (first position) of the moving vehicle 1 which receives a signal radiated from the antenna 2a by a radio wave (first signal which is a radio wave), and a coefficient which associates the acquired received power with the radio wave propagation environment of an estimation target position different from the received power measurement position (radio wave shielding state in an environment including a second position) is calculated (acquired). This configuration makes it possible to efficiently grasp the radio wave propagation environment in the target space in which the moving vehicle 1 moves, using the coefficient.

In the present embodiment, a received power map in which received power measured by the moving vehicle 1 at each position on the route along which the moving vehicle 1 moves is allocated to the positions is generated, and received power used to calculate the above-described coefficient is acquired from the generated received power map. In addition, in the present embodiment, the received power measurement position includes a position that is within the line of sight from the antenna 2a in a state in which the radio wave shielding object is disposed, and the estimation target position includes a position that is excluded from the line of sight from the antenna 2a by the radio wave shielding object in a state in which the radio wave shielding object is disposed. Moreover, the radio wave propagation environment of the estimation target position in the present embodiment includes the presence or absence of the radio wave shielding object.

That is, in the present embodiment, the above-described configuration makes it possible to calculate a coefficient for estimating the presence or absence of the radio wave shielding object which influences the radio wave propagation environment of the position excluded from the line of sight from the antenna 2a, using received power at the position within the line of sight from the antenna 2a.

In the present embodiment, received power is acquired more than once by moving the moving vehicle 1 along the same route more than once in a state in which the radio wave shielding object is disposed (first state) and a state in which the radio wave shielding object is not disposed (second state), and coefficients are calculated based on the received power acquired more than once. In this case, the coefficients which associate the received power acquired more than once with the values indicating the presence or absence of the radio wave shielding object (first and second states) at the time of the measurement of the received power are calculated, and the received power for calculating the coefficients is represented by, for example, linear values.

This configuration enables the coefficients to be calculated in consideration of the shifts in the position (travelling position) of the moving vehicle 1 moving along the same route and the position at which the moving vehicle 1 measures received power, and can improve the accuracy in estimating the presence or absence of the radio wave shielding object (radio wave propagation environment), using the coefficients.

In addition, the above-described received power acquired from the received power map in the present embodiment may be received power measured at the respective received power measurement positions close to reference positions set in advance. The configuration using these reference positions can equalize the numbers of components in the column direction of X to be substituted in Equation (19) described above and can calculate appropriate coefficients. In the case of a multipath-rich radio wave propagation environment, the spatial correlation between signals becomes lower at a half-wavelength. Accordingly, in order to prevent multicollinearity, in which an explanatory variable is correlated with another explanatory variable, the intervals between the reference positions may be set to be greater than or equal to the half-wavelength.

Moreover, depending on the condition of the radio wave propagation channel (propagation path), the spatial correlation may become high (that is, be influenced by multicollinearity) even when the reference positions are set far from each other. However, in the present embodiment, PLS regression, in which orthogonal components, that is, components having a low correlation are extracted, is applied to calculate coefficients. This configuration suppresses the unstableness of the coefficients under the influence of multicollinearity.

Furthermore, in the present embodiment, received power (second received power) measured by the moving vehicle 1 at a received power measurement position (third position) of the moving vehicle 1 which receives a signal (second signal) radiated from the antenna 2a by a radio wave is acquired. The coefficients calculated as described above and the acquired received power are used to estimate the radio wave propagation environment (state of radio wave shielding) of the estimation target position, and the moving vehicle 1 is controlled based on the estimation result. This configuration makes it possible to grasp the radio wave propagation environment of the estimation target position without moving the insensitive area (estimation target position behind the radio wave shielding object) and to control the moving vehicle 1 such that the moving vehicle 1 moves along an appropriate route (that is, improve the conveyance efficiency of loads in the target space).

Specifically, in the present embodiment, the presence or absence of the radio wave shielding object between the received power measurement position of the moving vehicle 1 and the estimation target position is estimated as the radio wave propagation environment of the estimation target position. This configuration makes it possible to grasp the sensitivity of the insensitive area including the estimation target position or the like, while moving (travelling) along a route including the received power measurement position at which received power is high.

In the present embodiment, when the radio wave shielding object is estimated to be present, the insensitive area is considered not to become sensitive and the moving vehicle 1 can be controlled to move along a route (first route) including the received power measurement position (that is, the route along which the moving vehicle 1 moves is not changed). In contrast, when the radio wave shielding object is estimated to be absent, the insensitive area is considered to become sensitive and the moving vehicle 1 can be controlled to move along a route (second route) including the estimation target position (that is, the route along which the moving vehicle 1 moves is changed). In the present embodiment, the above-described configuration makes it possible to improve the conveyance efficiency of loads while ensuring the stability of the operation of the moving vehicle 1.

In addition, in the present embodiment, coefficients are calculated, using received power measured at the received power measurement positions which shift whenever the moving vehicle 1 moves as described above (that is, coefficients are calculated in consideration of the influence of the shift). Thus, it is sufficient that the received power measurement position (first position) at which the received power used to calculate the coefficients is measured and the received power measurement position (third position) at which the received power used to estimate the presence or absence of the radio wave shielding object is measured are positions on the same route, and the positions need not be completely consistent with each other (may shift with respect to each other).

Moreover, in the present embodiment, the presence or absence of the radio wave shielding object can be estimated by, for example, comparing an estimated value (value of y) calculated by substituting regression coefficients and received power measured by the moving vehicle 1 at the received power measurement positions in Equation (22), with a threshold value (for example, 0.5).

Here, FIG. 16 illustrates estimated values calculated as described above in relation to measured received power (test data in cross-validation). The average value of the estimated values calculated in a state in which the radio wave shielding object is disposed in FIG. 16 is 0.716, and from these estimated values, the radio wave shielding object can be estimated to be present. In contrast, the average value of the estimated values calculated in a state in which the radio wave shielding object is not disposed in FIG. 16 is 0.3538, and from these estimated values, the radio wave shielding object can be estimated to be absent. That is, in the present embodiment, the presence or absence of the radio wave shielding object (radio wave propagation environment) can be estimated, based on the estimated values calculated using regression coefficients and received power.

Incidentally, in the present embodiment, it has been explained that the moving vehicle 1 is controlled, based on the estimation result of the presence or absence of the radio wave shielding object (radio wave propagation environment of the estimation target position). As illustrated in FIG. 16 described above, there are variations in the estimated values calculated using regression coefficients and received power, and there is a possibility that the estimation result of the presence or absence of the radio wave shielding object based on the estimated values is incorrect.

Here, FIG. 17 to FIG. 19 illustrate examples of the estimation results of the presence or absence of the radio wave shielding object obtained by using regression coefficients and received power. FIG. 17 to FIG. 19 illustrate the numbers of times the presence or absence of the radio wave shielding object is estimated in a matrix in association with whether the radio wave shielding object is actually disposed (that is, the actual presence or absence of the radio wave shielding object). Here, it is assumed that the presence or absence of the radio wave shielding object is estimated, based on estimated values calculated using received power measured at points near reference positions set at regular intervals of approximately two wavelengths.

First, FIG. 17 illustrates, for example, the estimation results of the presence or absence of the radio wave shielding object at the time of the movement along a predetermined route (hereinafter, referred to as a route R1). The example illustrated in FIG. 17 indicates that the number of times the radio wave shielding object is estimated to be present and the number of times the radio wave shielding object is estimated to be absent at the time of the movement along the route R1 in a state in which the radio wave shielding object is disposed are 8 and 4, respectively. Similarly, the example illustrated in FIG. 17 indicates that the number of times the radio wave shielding object is estimated to be present and the number of times the radio wave shielding object is estimated to be absent at the time of the movement along the route R1 in a state in which the radio wave shielding object is not disposed are 1 and 11, respectively. In this case, the estimation result that the radio wave shielding object is absent in the state in which the radio wave shielding object is disposed and the estimation result that the radio wave shielding object is present in the state in which the radio wave shielding object is not disposed are incorrect, and the number of times a correct estimation result is obtained is 19, out of the total 24 times the presence or absence of the radio wave shielding object is estimated. Accordingly, the accuracy of the estimation results (estimation accuracy) illustrated in FIG. 17 is expressed as 19/24≈79%.

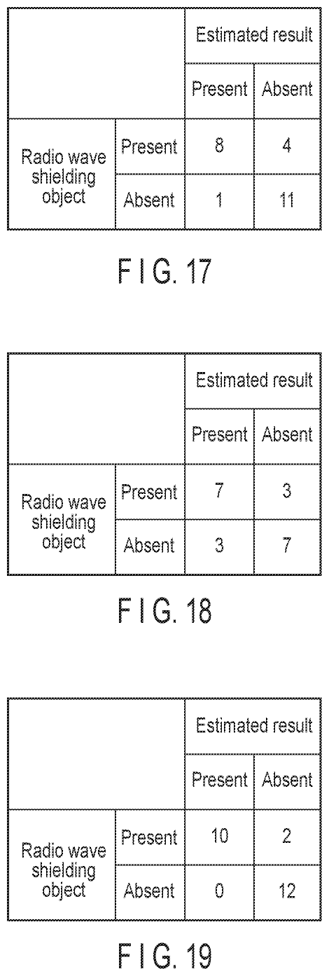

In addition, FIG. 18 illustrates the estimation results of the presence or absence of the radio wave shielding object at the time of the movement along a route (hereinafter, referred to as a route R2) different from the route R1 on another day than the day of the movement along the route R1 described above. The example illustrated in FIG. 18 indicates that the number of times the radio wave shielding object is estimated to be present and the number of times the radio wave shielding object is estimated to be absent at the time of the movement along the route R2 in a state in which the radio wave shielding object is disposed are 7 and 3, respectively. Similarly, the example illustrated in FIG. 18 indicates that the number of times the radio wave shielding object is estimated to be present and the number of times the radio wave shielding object is estimated to be absent at the time of the movement along the route R2 in a state in which the radio wave shielding object is not disposed are 3 and 7, respectively. In this case, the number of times a correct estimation result is obtained is 14, out of the total 20 times the presence or absence of the radio wave shielding object is estimated. Accordingly, the accuracy of the estimation results (estimation accuracy) illustrated in FIG. 18 is expressed as 14/20=70%.

Moreover, FIG. 19 illustrates the estimation results of the presence or absence of the radio wave shielding object at the time of the movement along the route R1 with the above-described reference positions optimized. The example illustrated in FIG. 19 indicates that the number of times the radio wave shielding object is estimated to be present and the number of times the radio wave shielding object is estimated to be absent at the time of the movement along the route R1 in a state in which the radio wave shielding object is disposed are 10 and 2, respectively. Similarly, the example illustrated in FIG. 19 indicates that the number of times the radio wave shielding object is estimated to be present and the number of times the radio wave shielding object is estimated to be absent at the time of the movement along the route R1 in a state in which the radio wave shielding object is not disposed is 0 and 12, respectively. In this case, the number of times a correct estimation result is obtained is 22, out of the total 24 times the presence or absence of the radio wave shielding object is estimated. Accordingly, the accuracy of the estimation results (estimation accuracy) illustrated in FIG. 19 is expressed as 22/24≈91%.

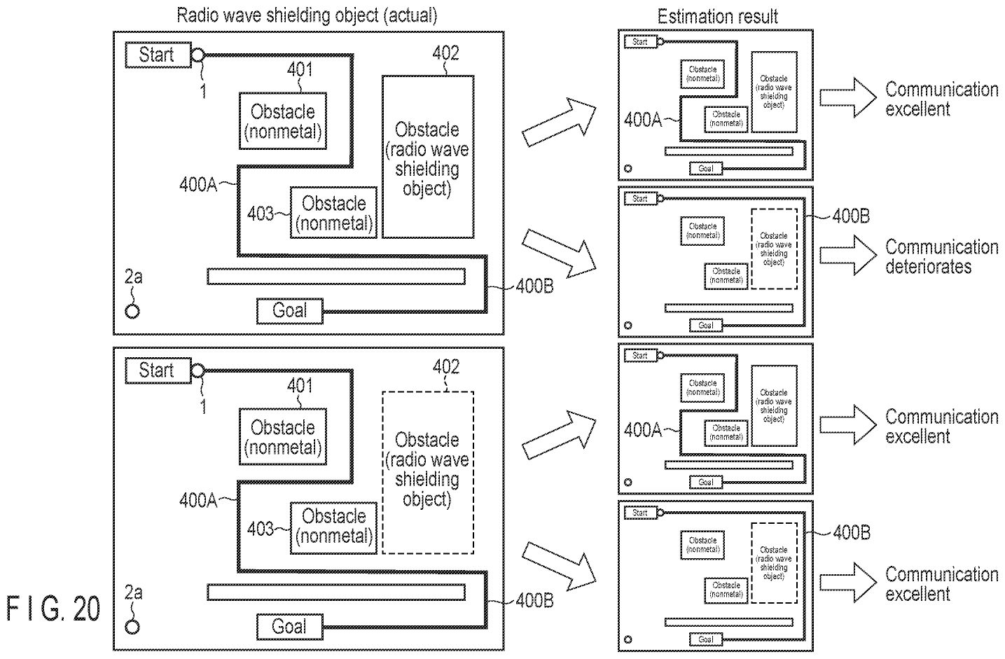

Here, the communication state based on the relationship between the actual presence or absence of the radio wave shielding object (obstacle 402) and the estimation result of the presence or absence of the radio wave shielding object in the above-described target space illustrated in FIG. 8 will be described with reference to FIG. 20.

As illustrated in FIG. 20, when the radio wave shielding object is estimated to be present at the time of the movement along the route 400A in a state in which the radio wave shielding object is actually present, this estimation result is correct. According to this estimation result, the moving vehicle 1 continuously moves along the route 400A, and thus the communication performed between the moving vehicle 1 and the antenna 2a is considered excellent.

In contrast, when the radio wave shielding object is estimated to be absent at the time of the movement along the route 400A in a state in which the radio wave shielding object is actually present, this estimation result is incorrect. According to this estimation result, the route along which the moving vehicle 1 moves is changed from the route 400A to the route 400B, and since the radio wave shielding object (obstacle 402) is actually present, the communication performed between the moving vehicle 1 moving behind the radio wave shielding object and the antenna 2a deteriorates.

Furthermore, when the radio wave shielding object is estimated to be present at the time of the movement along the route 400A in a state in which the radio wave shielding object is actually absent, this estimation result is incorrect. According to this estimation result, the moving vehicle 1 continuously moves along the route 400A, and thus the communication performed between the moving vehicle 1 and the antenna 2a is considered excellent.

In contrast, when the radio wave shielding object is estimated to be absent at the time of the movement along the route 400A in a state in which the radio wave shielding object is actually absent, this estimation result is correct. According to this estimation result, the route along which the moving vehicle 1 moves is changed from the route 400A to the route 400B. In this case, since the radio wave shielding object (obstacle 402) is not disposed actually, the communication performed between the moving vehicle 1 and the antenna 2a is considered excellent.

That is, four combinations are conceivable between the actual presence or absence of the radio wave shielding object and the estimation result of the presence or absence of the radio wave shielding object, but the minimum cases that must be avoided are limited. Specifically, for example, when the radio wave shielding object is estimated to be present in the case in which the radio wave shielding object is actually absent, this estimation result is incorrect, and the route 400A is not changed although the radio wave shielding object is actually absent. However, in this case, the excellent communication between the moving vehicle 1 and the antenna 2a is maintained, although the improvement in the conveyance efficiency of loads by the movement along the route 400B cannot be achieved. In contrast, when the radio wave shielding object is estimated to be absent in the case in which the radio wave shielding object is actually present, this estimation result is incorrect, and the route 400A is changed to the route 400B although the radio wave shielding object is actually present. In this case, the moving vehicle 1 moves behind the radio wave shielding object by moving along the route 400B, and there is a possibility that the communication between the moving vehicle 1 and the antenna 2a deteriorates and the moving vehicle 1 becomes out of control.

That is, even when an estimation result is incorrect, the estimation result does not greatly influence the operation of the moving vehicle control system as long as excellent communication can be maintained. In contrast, when the estimation result is incorrect and the communication deteriorates, it influences the operation of the moving vehicle control system. Therefore, in the present embodiment, the case in which the radio wave shielding object is estimated to be absent although the radio wave shielding object is actually present needs to be avoided.

For this reason, in the present embodiment, the moving vehicle 1 may be controlled (route may be changed), based on, for example, estimation results obtained by moving along a route including a received power measurement position more than once in consideration of the above situation (hereinafter, referred to as a first modified example of the present embodiment).

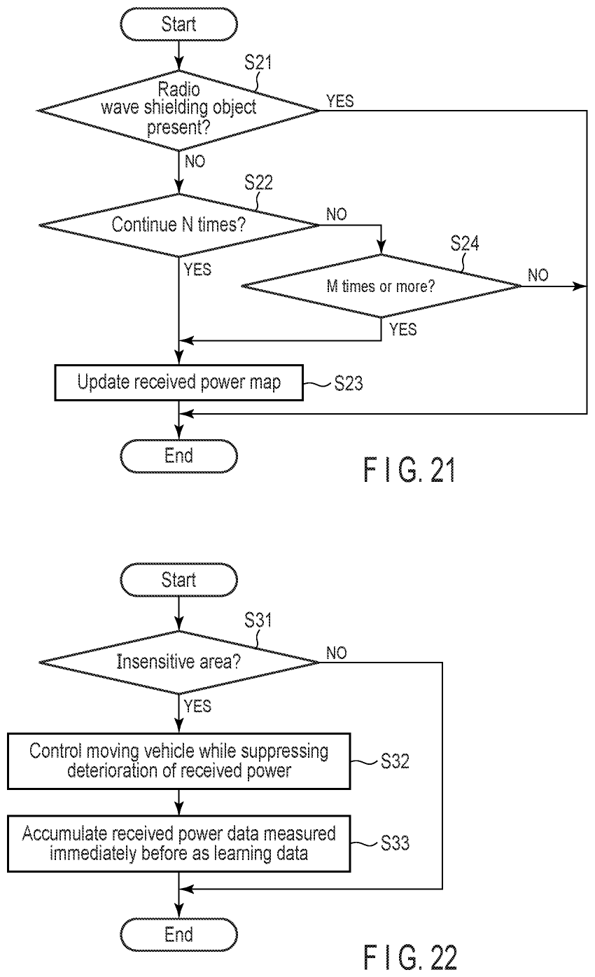

An example of a processing procedure of the information processing apparatus 3 according to the first modified example of the present embodiment will be described hereinafter with reference to the flowchart of FIG. 21.

The processing illustrated in FIG. 21 is executed instead of the above-described processing of step S18 illustrated in FIG. 15. In addition, while it has been explained that the processing of steps S12 to S18 is executed repeatedly in FIG. 15 described above, it is assumed that the estimation results of the presence or absence of the radio wave shielding object in step S17 (past estimation results at the time of the movement along the same route) are held in, for example, the processor 31.

First, the processor 31 (control module 31f) determines whether the radio wave shielding object has been estimated to be present in step S17 (step S21).

When it is determined that the radio wave shielding object has been estimated to be absent (NO in step S21), the processor 31 determines whether the estimation result that the radio wave shielding object is absent has been continuously obtained X times (that is, the radio wave shielding object has been continuously estimated to be absent N times), based on the past estimation results at the time of the movement along the same route held in the processor 31 (step S22). Note that N (number of times) used in step S22 is a numerical value greater than or equal to 2, and is set in advance.

When it is determined that the estimation result that the radio wave shielding object is absent has been continuously obtained N times (YES in step S22), the processor 31 makes the estimation result that the radio wave shielding object is absent reflected in the received power map and thereby updates the received power map (step S23). The processing of step S23 is the same as the above-described processing of updating the received power map in step S18 illustrated in FIG. 15, and thus, its detailed description is omitted here.

In contrast, when it is determined that the estimation result that the radio wave shielding object is absent has not been continuously obtained N times (NO in step S22), the processor 31 determines, for example, whether the number of times the radio wave shielding object has been estimated to be absent is M times or more, out of the estimation results of the past N times, based on the past estimation results at the time of the movement along the same route held in the processor 31 (step S24). Note that N and M in step S24 have, for example, the relationship of M>N/2, but may have a different relationship such as M>N/3 or M>N/4. In addition, N in step S24 may be a value equal to N in step S22 described above, or may be a different value.

When it is determined that the number of times the radio wave shielding object has been estimated to be absent is M times or more (YES in step S23), the above-described processing in step S23 is executed.

In contrast, when it is determined that the radio wave shielding object has been estimated to be present (YES in step S21) or when it is determined that the number of times the radio wave shielding object has been estimated to be absent is not M times or more (that is, less than M times) (NO in step S24), the processing of step S23 is not executed (that is, the received power map is not updated).

Here, in the above-described example illustrated in FIG. 17, the probability that excellent communication can be maintained, other than the case in which the radio wave shielding object is estimated to be absent although the radio wave shielding object is actually present (hereinafter, referred to as a case that should be avoided), is 20/24≈83%. Similarly, in the above-described example illustrated in FIG. 18, the probability that excellent communication can be maintained, other than the case that should be avoided, is 17/20=85%. In addition, in the above-described example illustrated in FIG. 19, the probability that excellent communication can be maintained, other than the case that should be avoided, is 22/24≈91%.

According to the examples illustrated in FIG. 17 to FIG. 19, the probability that the above-described case that should be avoided occurs is approximately 10% to 20%. That is, as explained in the above-described present embodiment, for example, when the route is changed at the timing at which the radio wave shielding object is estimated to be absent once, the probability that the moving vehicle 1 moves in the insensitive area (that is, the moving vehicle 1 becomes out of control in the insensitive area) is considered to be approximately 10% to 20%.

In contrast, the probability that the above-described case that should be avoided continuously occurs twice is approximately 1% (10%×10%) to 4% (20%×20%). Thus, in the first modified example of the present embodiment, as described above with reference to FIG. 21, when the estimation result that the radio wave shielding object is absent has been continuously obtained N (for example, 2) times, the received power map is updated (that is, the route is changed). By adopting this configuration, a situation in which the moving vehicle 1 moves in the insensitive area can be avoided. Note that N can be determined, based on, for example, the degree of the insensitive area (risk involved in the movement in the insensitive area) or the like.

In addition, in the first modified example of the present embodiment, even in the case in which the estimation result that the radio wave shielding object is absent has not been continuously obtained N times, when the radio wave shielding object has been estimated to be absent more than M times out of N times, it is possible to consider the probability of the radio wave shielding object being absent to be high under a majority rule and to update the received power map (that is, change the route).

In the first modified example of the present embodiment, it is sufficient that, for example, the moving vehicle 1 is controlled, based on estimation results of more than once (that is, the moving vehicle 1 is controlled to move along the route including the estimation target position when the radio wave shielding object has been estimated to be absent more than once). In the first modified example of the present embodiment, for example, the processing illustrated in FIG. 21 may be executed with part of the processing changed. Specifically, in the first modified example of the present embodiment, only the processing of one of steps S22 and S24 illustrated in FIG. 21 may be executed.

Here, in the present embodiment and the first modified example of the present embodiment described above, there can be a possibility that the moving vehicle 1 moves in the insensitive area when the moving vehicle 1 is controlled, based on the estimation result of the presence or absence of the radio wave shielding object. Thus, when the moving vehicle 1 moves in the insensitive area, regression coefficients may be updated, using the presence of the insensitive area (hereinafter, referred to as a second modified example of the present embodiment).

An example of a processing procedure of the information processing apparatus 3 according to the second modified example of the present embodiment will be described hereinafter with reference to the flowchart of FIG. 22.

Note that the processing illustrated in FIG. 22 is executed, for example, while the moving vehicle 1 is being controlled to move along the second route including the estimation target position (that is, the moving vehicle 1 is moving along the second route), after the radio wave shielding object is estimated to be absent by the movement along the above-described first route including the received power measurement position.

First, the moving vehicle 1 transmits received power data indicating received power measured at each position during the movement along the second route to the information processing apparatus 3 via the base station 2. In this case, the processor 31 (acquisition module 31a) included in the information processing apparatus 3 acquires the received power data transmitted from the moving vehicle 1 moving along the second route from the base station 2.

Here, the processor 31 (control module 31f) determines whether the moving vehicle 1 is moving in the insensitive area, based on the received power data acquired as described above (step S31). The processing of step S31 is executed, based on, for example, whether the received power indicated by the acquired received power data deteriorates to an extent that the moving vehicle 1 can be considered to be in the insensitive area, compared to past received power.

When it is determined that the moving vehicle 1 is moving in the insensitive area (YES in step S31), the processor 31 controls the moving vehicle 1 such that the moving vehicle 1 can pass through the insensitive area while suppressing the deterioration of received power by, for example, using time diversity, frequency diversity, or spatial diversity (step S32).

In step S32, it is sufficient that the processing intended to allow the moving vehicle 1 moving in the insensitive area to pass through the insensitive area without becoming out of control is executed. Specifically, for example, the processing of changing the operation mode of the moving vehicle 1 to a highly reliable mode for suppressing the deterioration of received power may be executed, or the processing of relaying a control signal transmitted from the base station 2 to the moving vehicle 1 by another moving vehicle may be executed.

Here, from the fact that the moving vehicle 1 is moving along the second route, in which the insensitive area occurs, as described above, it can be considered that the estimation result of the presence or absence of the radio wave shielding object (estimation result that the radio wave shielding object is absent) at the time of the movement along the first route is incorrect and the radio wave shielding object is actually disposed. Accordingly, when a long period of time has not elapsed since the movement along the first route, it is highly likely that the radio wave shielding object was already disposed at the time of the movement along the first route.

That is, it is considered that the moving vehicle 1 which was moving along the first route before the change to the above-described second route measured received power along the first route in a state in which the radio wave shielding object was disposed. In the second modified example of the present embodiment, the above-described information indicating that the radio wave shielding object is present (that is, the value indicating that the radio wave shielding object is present) and the received power measured (at the received power measurement position) on the first route along which the moving vehicle 1 was moving immediately before moving along the second route, in which the insensitive area occurs, are accumulated in, for example, the storage 32 as (part of) the above-described learning data (step S33).

In the second modified example of the present embodiment, learning data can be accumulated, for example, whenever the moving vehicle 1 moves in the insensitive area because of the incorrectness of an estimation result as described above, and the learning data can be used to update (calculate again) the regression coefficients. According to the configuration like this, there is a possibility that the regression coefficients that can achieve higher estimation accuracy can be obtained.

When it is determined that the moving vehicle 1 is not moving in the insensitive area (NO in step S31), the processing of steps S32 and S33 is not executed.

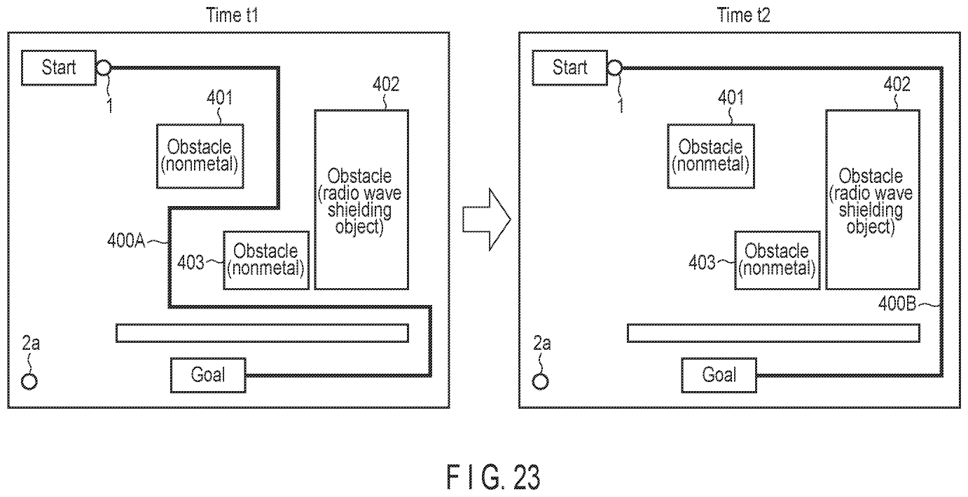

Here, the second modified example of the present embodiment will be specifically described with reference to FIG. 23. As illustrated in FIG. 23, it is assumed here that in the above-described target space illustrated in FIG. 8, the radio wave shielding object was estimated to be absent when the moving vehicle 1 moved along the route 400A at a time t1, so that the moving vehicle 1 moves along the route 400B, changed from the route 400A, at a time t2 after the time t1.

In this case, for example, assuming that the received power measured by the moving vehicle 1 moving along the route 400B deteriorates (that is, the insensitive area occurs on the route 400B), it can be grasped that the radio wave shielding object (obstacle 402) is disposed.

Accordingly, it is considered that the radio wave shielding object (obstacle 402) was disposed also at the time t1 when the moving vehicle 1 moved along the route 400A, and the value indicating that the radio wave shielding object is present (that is, y=1) and the received power measured by the moving vehicle 1 at the time of the movement along the route 400A at the time t1 are used as learning data.

It is assumed here that the difference between the time t1 and the time t2 is less than a predetermined value (that is, the interval between the time t1 and the time t2 is short to an extent that it can be considered that the radio wave shielding object was disposed also at the time t1). However, when the difference between the time t1 and the time t2 is greater than or equal to the predetermined value, the received power measured by the moving vehicle 1 at the time of the movement along the route 400A at the time t1 may not be used as learning data.

In the above-described second modified example of the present embodiment, when the estimation result of the presence or absence of the radio wave shielding object is incorrect (that is, the moving vehicles 1 moves in the insensitive area), the incorrectness of the estimation result can be used to update the regression coefficients (improve accuracy). In other words, in the second modified example of the present embodiment, it is possible to increase the estimation accuracy of the presence or absence of the radio wave shielding object (that is, increase the accuracy of path control) while updating the regression coefficients during the operation of the moving vehicle control system.

In the present embodiment, it has been explained that as illustrated in FIG. 6, the processor 31 includes the calculation module 31d and the estimation module 31e (that is, the information processing apparatus 3 has both the function of calculating coefficients and the function of estimating the radio wave propagation environment of the estimation target position). However, the information processing apparatus 3 according to the present embodiment may be configured to have one of the functions (that is, execute only one of the above-described learning processing and estimation processing).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

With regard to the above-described embodiments, the following supplementary notes are further disclosed.

(1)

An information processing apparatus including a processor configured to:
acquire first received power measured by a moving vehicle at a first position of the moving vehicle which receives a first signal which is a radio wave; and
acquire a coefficient which associates the acquired first received power with a radio wave shielding state in an environment including a second position different from the first position.

(2)

The information processing apparatus of (1), wherein the processor is configured to
generate a received power map in which positions on a route along which the moving vehicle moves are associated with received power measured by the moving vehicle, and
acquire the first received power measured at the first position from the generated received power map.

(3)

The information processing apparatus of (1) or (2), wherein
the first position is a position at which the radio wave is receivable in a state in which a radio wave shielding object is disposed in the environment, and
the second position is a position at which received power of the radio wave by the environment deteriorates in a state in which the radio wave shielding object is disposed in the environment.

(4)

The information processing apparatus of any one of (1) to (3), wherein
the radio wave shielding state in the environment including the second position includes whether the radio wave shielding object is present or absent.

(5)

The information processing apparatus of any one of (1) to (4), wherein the processor is configured to
acquire first received power more than once at the first position of the moving vehicle in each of a first state in which the radio wave shielding object is disposed in the environment and a second state in which the radio wave shielding object is not disposed in the environment, and
acquire the coefficient, based on the first received power acquired more than once.

(6)

The information processing apparatus of (5), wherein
the processor is configured to acquire coefficients which associate the first received power acquired more than once with values indicating the first and second states at a time of measurement of the first received power acquired more than once, and
the first received power acquired more than once is represented by linear values.

(7)

The information processing apparatus of (2), wherein
the processor is configured to acquires the first received power measured at the first position from the generated received power map, the first position being located within a predetermined range based on reference positions set in advance.

(8)

The information processing apparatus of any one of (1) to (7), wherein
the processor is configured to acquire the coefficient by applying partial least squares (PLS) regression.

(9)

The information processing apparatus of any one of (1) to (8), wherein the processor is configured to
acquire second received power measured by the moving vehicle at a third position,
estimate the radio wave shielding state in the environment including the second position, using the acquired coefficient and the second received power, and
control the moving vehicle, based on the estimation result.

(10)

The information processing apparatus of (9), wherein
the first and third positions are positions on a same route of routes for controlling the moving vehicle.

(11)

The information processing apparatus of (9) or (10), wherein
the processor is configured to estimate whether a radio wave shielding object is present or absent between the second position and the third position, using the coefficient and the second received power.

(12)

The information processing apparatus of (11), wherein the processor is configured to
control the moving vehicle such that the moving vehicle moves along a first route including the third position, when the radio wave shielding object is estimated to be present, and
control the moving vehicle such that the moving vehicle moves along a second route including the second position, when the radio wave shielding object is estimated to be absent.

(13)

The information processing apparatus of (12), wherein
the processor is configured to control the moving vehicle such that the moving vehicle moves along the second route, when the radio wave shielding object is estimated to be absent more than once.

(14)

An information processing apparatus including a processor configured to:
hold a coefficient which associates first received power measured by a moving vehicle at a first position of the moving vehicle which receives a first signal which is a radio wave with a radio wave shielding state in an environment including a second position different from the first position;
acquire second received power measured by the moving vehicle at a third position;
estimate the radio wave shielding state in the environment including the second position, using the held coefficient and the second received power; and
control the moving vehicle, based on the estimation result.

(15)

The information processing apparatus of (14), wherein
the first and third positions are positions on a same route of routes for controlling the moving vehicle.

(16)

The information processing apparatus of (14) or (15), wherein
the processor is configured to estimate whether a radio wave shielding object is present or absent between the second position and the third position, using the coefficient and the second received power.

(17)

The information processing apparatus of (16), wherein the processor is configured to
control the moving vehicle such that the moving vehicle moves along a first route including the third position, when the radio wave shielding object is estimated to be present, and
control the moving vehicle such that the moving vehicle moves along a second route including the second position, when the radio wave shielding object is estimated to be absent.

(18)

The information processing apparatus of (17), wherein
the processor is configured to control the moving vehicle such that the moving vehicle moves along the second route, when the radio wave shielding object is estimated to be absent more than once.

(19)

A system including:
the information processing apparatus of any one of (1) to (18); and
a moving vehicle communicably connected to the information processing apparatus.

(20)

A non-transitory computer-readable storage medium having stored thereon a program which is executed by a computer, the program including instructions capable of causing the computer to execute function of:
acquiring first received power measured by a moving vehicle at a first position of the moving vehicle which receives a first signal which is a radio wave; and
associating the acquired first received power with a radio wave shielding state in an environment including a second position different from the first position.

What is claimed is:

1. An information processing apparatus comprising a processor configured to:
acquire first received power measured by a moving vehicle at a first position of the moving vehicle which receives a first signal which is a radio wave; and
acquire a coefficient which associates the acquired first received power with a radio wave shielding state in an environment including a second position different from the first position.

2. The information processing apparatus of claim 1, wherein the processor is configured to
generate a received power map in which positions on a route along which the moving vehicle moves are associated with received power measured by the moving vehicle, and
acquire the first received power measured at the first position from the generated received power map.

3. The information processing apparatus of claim 2, wherein
the first position is a position at which the radio wave is receivable in a state in which a radio wave shielding object is disposed in the environment, and
the second position is a position at which received power of the radio wave by the environment deteriorates in a state in which the radio wave shielding object is disposed in the environment.

4. The information processing apparatus of claim 3, wherein
the radio wave shielding state in the environment including the second position includes whether the radio wave shielding object is present or absent.

5. The information processing apparatus of claim 4, wherein the processor is configured to
acquire first received power more than once at the first position of the moving vehicle in each of a first state in which the radio wave shielding object is disposed in the environment and a second state in which the radio wave shielding object is not disposed in the environment, and
acquire the coefficient, based on the first received power acquired more than once.

6. The information processing apparatus of claim 5, wherein
the processor is configured to acquire coefficients which associate the first received power acquired more than once with values indicating the first and second states at a time of measurement of the first received power acquired more than once, and
the first received power acquired more than once is represented by linear values.

7. The information processing apparatus of claim 2, wherein
the processor is configured to acquires the first received power measured at the first position from the generated received power map, the first position being located within a predetermined range based on reference positions set in advance.

8. The information processing apparatus of claim 1, wherein
the processor is configured to acquire the coefficient by applying partial least squares (PLS) regression.

9. The information processing apparatus of claim 1, wherein the processor is configured to
acquire second received power measured by the moving vehicle at a third position,
estimate the radio wave shielding state in the environment including the second position, using the acquired coefficient and the second received power, and
control the moving vehicle, based on the estimation result.

10. The information processing apparatus of claim 9, wherein
the first and third positions are positions on a same route of routes for controlling the moving vehicle.

11. The information processing apparatus of claim 9, wherein
the processor is configured to estimate whether a radio wave shielding object is present or absent between the second position and the third position, using the coefficient and the second received power.

12. The information processing apparatus of claim 11, wherein the processor is configured to
control the moving vehicle such that the moving vehicle moves along a first route including the third position, when the radio wave shielding object is estimated to be present, and
control the moving vehicle such that the moving vehicle moves along a second route including the second position, when the radio wave shielding object is estimated to be absent.

13. The information processing apparatus of claim 12, wherein
the processor is configured to control the moving vehicle such that the moving vehicle moves along the second route, when the radio wave shielding object is estimated to be absent more than once.

14. An information processing apparatus comprising a processor configured to:
hold a coefficient which associates first received power measured by a moving vehicle at a first position of the moving vehicle which receives a first signal which is a radio wave with a radio wave shielding state in an environment including a second position different from the first position;
acquire second received power measured by the moving vehicle at a third position;
estimate the radio wave shielding state in the environment including the second position, using the held coefficient and the second received power; and
control the moving vehicle, based on the estimation result.

15. The information processing apparatus of claim 14, wherein
the first and third positions are positions on a same route of routes for controlling the moving vehicle.

16. The information processing apparatus of claim 14, wherein
the processor is configured to estimate whether a radio wave shielding object is present or absent between the second position and the third position, using the coefficient and the second received power.

17. The information processing apparatus of claim 16, wherein the processor is configured to
control the moving vehicle such that the moving vehicle moves along a first route including the third position, when the radio wave shielding object is estimated to be present, and
control the moving vehicle such that the moving vehicle moves along a second route including the second position, when the radio wave shielding object is estimated to be absent.

18. The information processing apparatus of claim 17, wherein
the processor is configured to control the moving vehicle such that the moving vehicle moves along the second route, when the radio wave shielding object is estimated to be absent more than once.

19. A system comprising:
the information processing apparatus of claim 1; and
a moving vehicle communicably connected to the information processing apparatus.

20. A non-transitory computer-readable storage medium having stored thereon a program which is executed by a computer, the program comprising instructions capable of causing the computer to execute function of:
acquiring first received power measured by a moving vehicle at a first position of the moving vehicle which receives a first signal which is a radio wave; and
associating the acquired first received power with a radio wave shielding state in an environment including a second position different from the first position.
